(19) United States
(12) Patent Application Publication
(10) Pub. No.: US 2002/0122063 A1
(43) Pub. Date: Sep. 5, 2002

(54) System and method for storing and displaying information

(76) Inventors: Carl B. Weinberg, Chappaqua, NY (US); Carisa Anne Worden, Mount Vernon, NY (US); Ian Charles Shepherdson, Mount Kisko, NY (US); Valencia L. Ondes, South Salem, NY (US); Christopher Robert Hobbs, London (GB)

Correspondence Address: PENNIE AND EDMONDS, 1155 AVENUE OF THE AMERICAS, NEW YORK, NY, 100362711

(21) Appl. No.: 09/750,782

(22) Filed: Dec. 29, 2000

(51) Int. Cl. G06F 3/14; G06F 13/00

(52) U.S. Cl. 345/764; 345/765

(57) ABSTRACT

A preferred embodiment of the present invention comprises a method and system for electronically displaying information, comprising the steps of: (1) displaying a grid to a user, wherein each column and each row of the grid represents a category of data, wherein each column-row element of the grid corresponds to column-row data, and wherein each column-row element of the grid comprises a visual indicator relating to the column-row data; (2) receiving a request from the user to have selected column-row data displayed; and (3) displaying the selected column-row data to the user. Preferably, the color of the visual indicator relates to a quality of said column-row data, such as how important the data is. Also, the size of the visual indicator preferably relates to the quantity of the column-row data.

### FIELD OF THE INVENTION

The subject invention is related to storing and displaying information, more particularly to storing and displaying in an ergonomically-advantageous format information transmitted over a computer network.

### BACKGROUND

For an ever-increasing segment of the global population, the Internet has become the primary medium for gathering and distributing a limitless array of information. In particular, the World Wide Web (“the Web”) now allows a global audience of Internet users access to information and services provided by enterprises and individuals instantaneously, without regard to time or geographical locus.

The universe of information available on the Web continues to expand rapidly. Unfortunately, the development of effective organizational structures has not kept pace with the explosion of Web content, causing vast pools of information to remain essentially obscure because they are too confusing or time-consuming to access. One of the greatest obstacles to the further evolution of the Web therefore lies not in expanding the universe of available information, but in the development of effective mechanisms for organizing and filtering this information.

Indeed, since much information available on the Web is no longer unique in either substance or quality, enterprise content providers may find that offering their users efficiently-organized, accessible information is the most effective opportunity for distinguishing themselves from competitors and adding value to their products and services.

Organizing information on a Website involves superimposing an information architecture; this architecture forms the basis for the navigation system of the Website. A navigation system using hyperlinks—which facilitate connections between content elements—creates a structured mechanism for allowing users to access information available on a Website. Deficiencies in currently available information architectures and their accompanying navigation systems can lead to a level of disorganization such that a user becomes unable to find efficiently the information he or she needs. If information is inaccessible, it has essentially no value. Organizational problems that can reduce the perceived value of information include (1) poor scalability of information architectures; (2) inconsistencies in logic and implementation of information architectures, and (3) the implementation of generic information architectures in diverse subject areas.

Content geared toward participants in the global financial markets suffers from such ineffective information organization. Market participants—both private individuals and financial institutions—depend on quick access to content that will inform their investment decisions. Because the financial markets are greatly affected by time-specific events, the majority of Web content geared toward financial market participants is related to reportage and analysis of such events. These events include—but are not limited to—the release of economic statistics by official and industry agencies, the conduct of government debt auctions, and meetings of international economic and financial supervisory institutions. It is important for market participants to plan for these events and to evaluate their potential impact on the markets. In forming investment strategies, it is necessary to have focused, detailed information pertaining to these events, as well as a broader horizon for their contextualization. Indeed, such a perspective is valuable in any subject area where the focus is on events or data that can be similarly categorized.

Presenting these perspectives through prose is ineffective, since it typically generates additional content that is time-consuming to read and difficult to absorb quickly. Ideally, these perspectives would be facilitated by representing the information in such a way that the form of the information augments its meaning and utility.

Known solutions for implementing information architectures and their accompanying navigational systems fail to meet the needs of content users active in the financial markets. The predominant methods of using hierarchies to organize information can lead users deep into hierarchies that are both confusing to navigate and unhelpful in clearly establishing interrelationships between events or content elements. Structuring event-related information in a calendar model helps to orient the user, relieving some of the above-mentioned navigational difficulties. Yet a simple calendar model does not adequately map the information available, only the potential for information. This can be even more confusing in that users may believe there is information available because a given time period (such as a day) is represented even though that data space may actually be empty. This leads to the unnecessary consumption of time loading irrelevant Web pages. These organizational and navigational difficulties are only escalated when the data relating to events is distinguished not only by time but also by a second dimension, such as a given market, economy or other category.

Thus, there is a need for a sophisticated, yet easy-to-use, system of storing and representing data relating to events in the financial markets industry—or any such field that deals with similarly categorized information. The system would preferably also augment the value of the provided information by fostering the conceptualization of interrelationships between events and related information. This system would preferably include a graphical user interface (GUI) that provides a unified context for viewing both the available data and the status of the user interaction. The system would preferably also include a GUI for a system operator to input and administer the data.

### SUMMARY

In one aspect, the present invention is a method for electronically displaying information, comprising the steps of: (1) displaying a grid to a user, each column and each row of the grid representing a category of data, wherein each column-row element of the grid corresponds to column-row data (data that is both in the corresponding column category of data and in the corresponding row category of data), and wherein each column-row element of the grid comprises a visual indicator relating to the column-row data; (2) receiving a request from the user to display selected column-row data; and (3) displaying the selected column-row data to the user. It is important to distinguish between a column-row element and corresponding column-row data. A column row element is displayed in the grid and is preferably linked to a display that comprises column-row data. In a preferred embodiment, column-row data does not appear in the grid.

Preferably, the color of the visual indicator relates to a quality of said column-row data, such as how important the data is. Also, the size of the visual indicator preferably relates to the quantity of the column-row data. For example, if the data comprises event records (discussed below), the size of the indicator is roughly proportional to the number of event records that relate to the selected column and row.

In a preferred embodiment, each column of the grid corresponds to a day of the week (Monday, Tuesday, Wednesday, Thursday, or Friday), the entire week, or some day as yet undetermined (“Sometime”). Preferably, each row of the grid corresponds to a country or area of the world (e.g., Germany or Europe).

A preferred embodiment also provides tabs along the top and one side of a rectangular viewing area. Preferably the top tabs correspond to the columns of the grid. The side tabs comprise tabs corresponding to the rows of the grid (i.e., countries), as well as a “world” tab and a “custom” tab that enables a user to customize what information is displayed.

In a preferred embodiment, a user selects column-row data that the user wishes to have displayed by placing a mouse cursor over a corresponding column-row element and clicking the mouse button. However, a user preferably can also select column-row data by clicking on the top and side tabs that correspond to the column and row of the desired column-row element.

The column-row data preferably comprises textual information relating to an event (or events) that is (are) expected to occur on a selected day and relating to a selected country. To provide an intuitive summary of the nature of the expected outcome of a selected event, a preferred embodiment displays, adjacent to the textual information describing that expected outcome, a weather icon. Each weather icon (sunny, cloudy, rainy, etc.) provides a visual summary of the expected outcome according to an anticipated perspective of a canonical user. For example, if the expected outcome of an announcement on Tuesday regarding interest rates in Germany is that the rates will be increased, the icon adjacent to that prediction is a rainy icon—even though a minority of users might welcome such an increase.

### BRIEF DESCRIPTION OF DRAWINGS

FIG. 1A depicts components of a preferred system.

FIG. 1B depicts an Administrative Interface (Control Panel) page.

FIG. 2 depicts a Menus-Control Panel page.

FIG. 3 depicts a Create Week-Control Panel page.

FIG. 4 depicts an Update Week-Control Panel page.

FIG. 5 depicts an Update Climate-Control Panel page.

FIG. 6 depicts a Special Notes-Control Panel page.

FIG. 7A depicts an Add Event Record-Control Panel page.

FIG. 7B depicts an Edit Event Record-Control Panel page.

FIG. 8A depicts a Home End-User Interface page.

FIG. 8B depicts a MiniGrid blank frame display.

FIG. 8C depicts a World-Week View page.

FIG. 9 depicts a Large Note (Blank)-End-User Interface page.

FIG. 10 depicts Weather Icons.

FIG. 11 depicts a MiniGrid Samples page.

FIG. 12 depicts a Small Note Sheet page.

FIG. 13 depicts a Country-Day View (U.S.—Wednesday) page.

FIG. 14 depicts a Country-Week View (United Kingdom—Week) page.

FIG. 15A depicts a World-Day View (World—Wednesday) page.

FIG. 15B depicts an Event Record-End-User Interface page for an Event that has not yet occurred.

FIG. 15C depicts an Event Record-End-User Interface page for an Event that has occurred.

FIG. 16 depicts an Event Record-End-User Interface page.

FIG. 17 depicts Event Record Fields.

FIG. 18 provides a system architecture overview.

FIG. 19 shows programming languages for End-User Interface Components.

FIG. 20 illustrates principle data flow in a preferred server.

FIG. 21 illustrates steps of a preferred method for a preferred interface to adapt to a user-selected link.

FIG. 22 illustrates steps of a preferred method for a preferred interface to adapt to a user-selected view.

FIGS. 23 and 24 illustrate steps of a preferred method for constructing a view.

FIG. 25 illustrates steps of a preferred method for calculating events for representation in a MiniGrid.

FIG. 26 illustrates steps of a preferred method for compiling MiniGrid images.

### DETAILED DESCRIPTION OF PREFERRED EMBODIMENTS

### I. Data Model

A. Data properties

At the most fundamental level, the database used in a preferred embodiment is simply a collection of event records. For the purposes of this description, an event record is any data comprising text, data, charts, or other media which pertain to a discrete event in the real world. The elements that constitute an event record are discussed in greater detail below. In the preferred embodiment, each event record is identified uniquely by a combination of three key fields: Time, Country, and Event Number. The purpose of the Event Number field is to discriminate between events with the same Time and Country value. Any single combination of these three fields refers to either one or zero event records. Each event record is associated with exactly one value for each of the three key fields. Depending on the implementation, alternative embodiments may or may not require all event records to have an identical set of fields. Preferably, there is no such requirement.

In a preferred embodiment, the Time field is represented as separate Week and Day fields. The Week field corresponds to discrete one-week periods of real time. The Day field generally corresponds to weekdays in real time occurring within discrete one-week periods. The Day field values correspond to “Day” values displayed in the user interface (discussed below). For storage, records are grouped into Weeks, and within these Week groups are sorted by Country category, then by Day, and finally by Event Number. This hierarchical subdivision of the database is done for efficiency reasons: almost all operations on the database are carried out within the scope of either a single Week data set or a single event record. By organizing data storage along these boundaries, the most-commonly-required database subsets can be retrieved more quickly.

Alternative embodiments do not employ such a hierarchy (for example, when a relational database management system is used to store the data); or they employ a different hierarchy.

B. Conceptual Grid

Underlying the semantics of the user interface is a conceptual grid—a data model designed to increase human understanding of the data, rather than for the technical implementation. The conceptual grid provides the user with an artificial sense of physical location within the set of possible views on the data.

In the following description, view refers to a subset of the database, as seen by the user. For instance, “World-Monday” defines a view containing a listing of all the event records associated with Monday for a given Week. There is a large number of possible views on the database, but the design of the client system determines what views a user may choose to see. As used here, the term “view” refers only to a particular subset of the database, and not to the visual appearance of that subset. That is, many different presentations of a given view are possible.

The advantage of arranging data in a two-dimensional grid, with each dimension representing a property of the data, is that it allows a viewing user (“viewer”) to understand intuitively where a particular item can be found based on those key properties.

The conceptual grid extends this familiar idea so that a viewer is easily able to locate not just particular items, but also particular views on the available data. For instance, the interface defines “the Week” (i.e., all Day categories) as being located on the same axis as “Monday”; “the World” (i.e., all Country categories) is on the same axis as Country categories.

Two advantages of this arrangement are that the user implicitly understands: (1) what views are available (e.g., the user knows that it is possible simultaneously to view all categories for the entire week, since this is the “top left corner” of the conceptual grid); and (2) how to select any given view (e.g., to change from viewing “Country A on Wednesday” to “all Countries (the World) on Wednesday” involves “moving upward”).

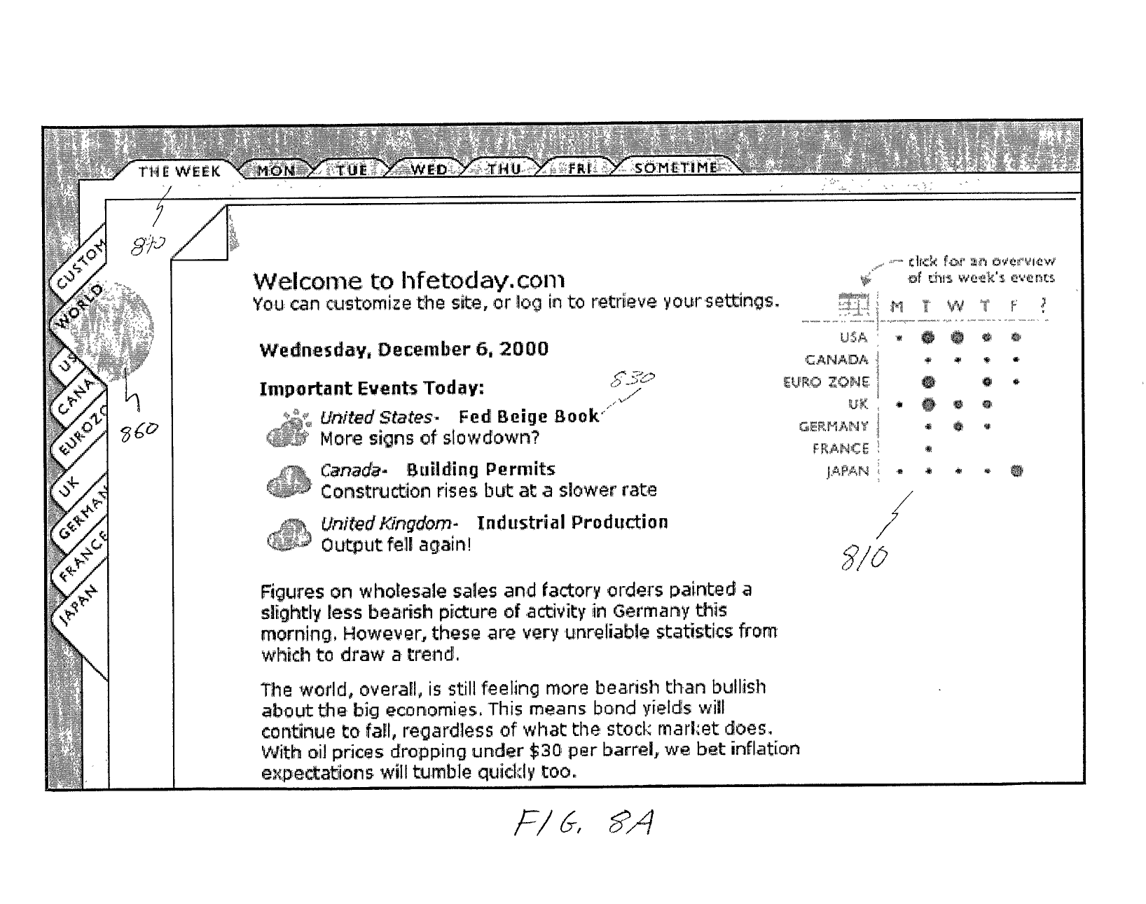

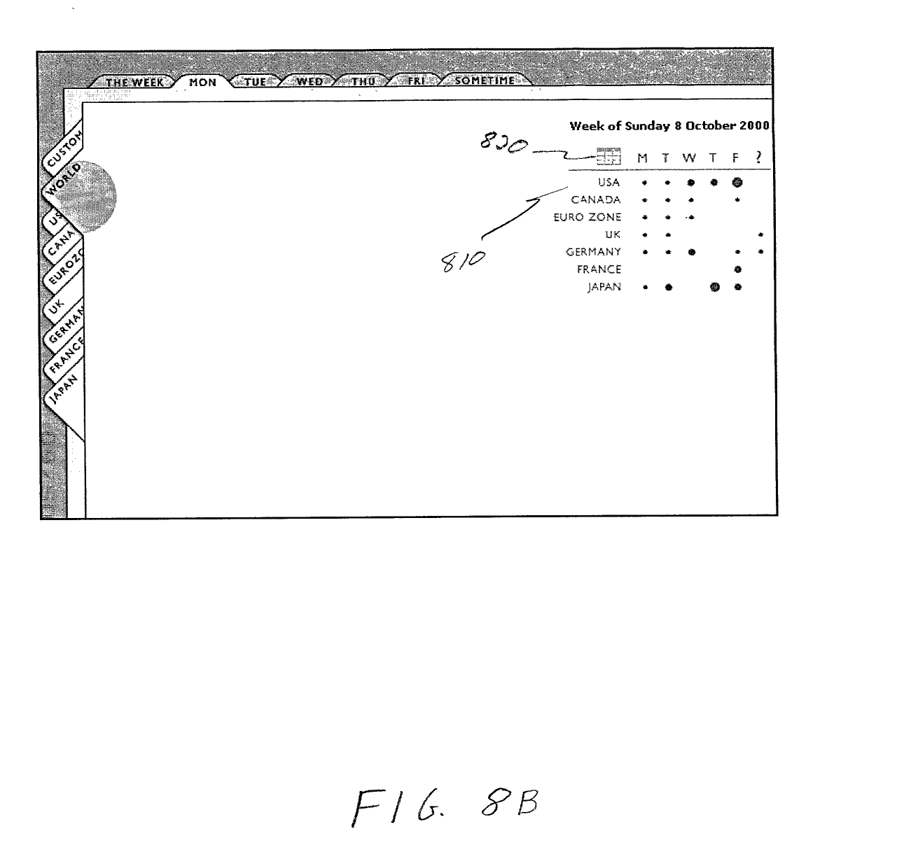

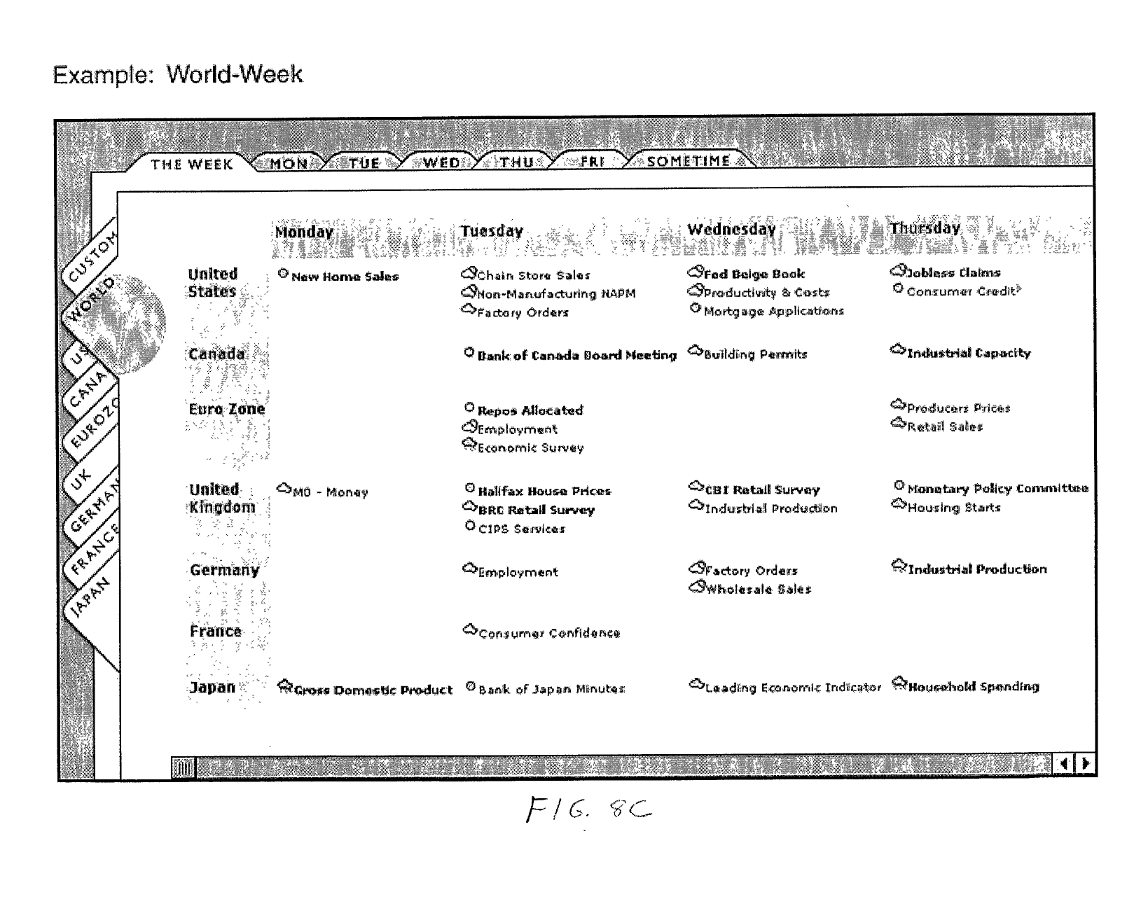

Any view can in principle be diagrammatically displayed on the MiniGrid (a navigational and informational component of a preferred embodiment of the invention—see, e.g., FIGS. 8A and 8B). The MiniGrid can also be used to access the views it displays. The MiniGrid is flexible enough to present the user with almost any view option (e.g., “Odd-numbered categories only” could be supported by selecting alternate rows on the MiniGrid), while restricting the user to only those view options that are in fact supported. The MiniGrid is described in detail in the “User Interface” section below.

### II. User Interface

A. Data administration interface

Data input and maintenance are performed using a nonpublic collection of web-page interfaces: the Control Panel. The Control Panel is accessed through a standard browser. In one embodiment, a data administrator supplies a username and password to gain access to the Control Panel. Alternatively, Internet Protocol (IP) addresses can be used to authorize access to the Control Panel; any network device that does not use an IP address authorized by the server will be denied access to the Control Panel. Alternatively, any number of known Internet security devices could be used to restrict access to the Control Panel.

In a preferred embodiment, the Control Panel enables at least the following functions: (1) creating new Week data sets; (2) creating “Special Notes” (discussed below); (3) creating, editing, or deleting event records pertaining to past, current, or future Week data sets; (4) uploading graphics (such as charts or illustrations) related to event records, in acceptable web formats; (5) updating the data version displayed to end-users; and (6) updating “Climate” data (discussed below).

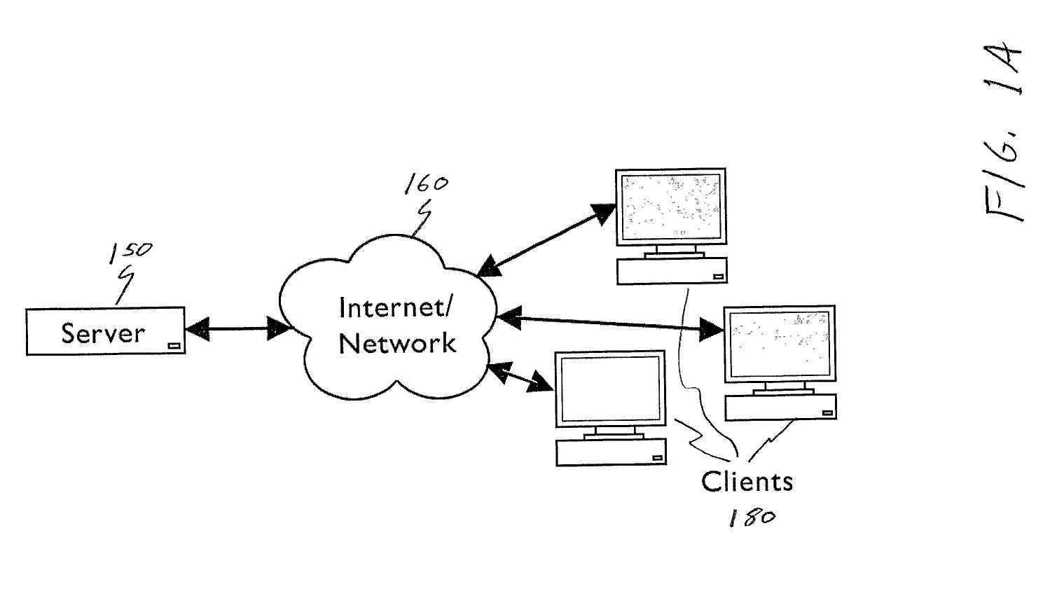

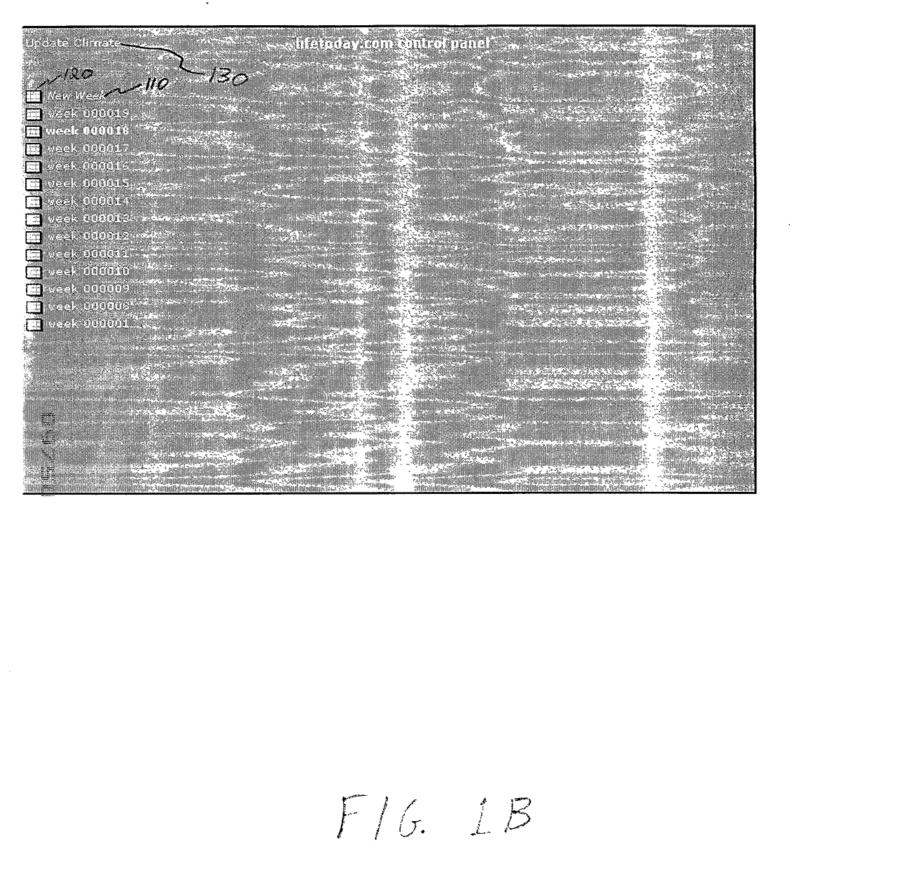

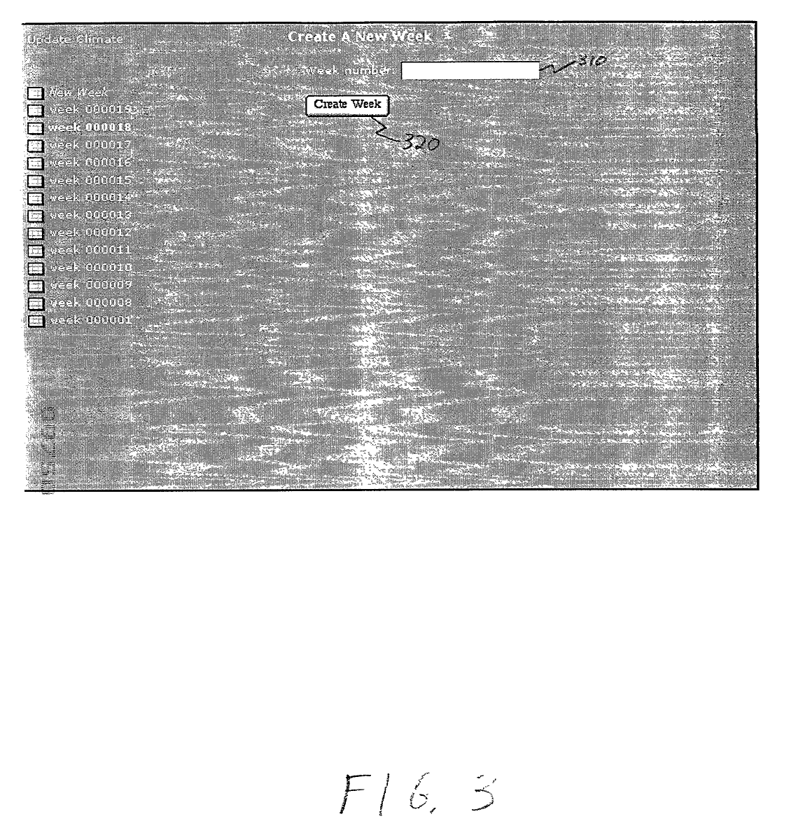

In the preferred embodiment, a data administrator creates a Week data set by clicking a “Create New Week” link 110, or its accompanying icon 120, found at the Control Panel, as shown, e.g., in FIG. 1B. A “Create a New Week” page is then displayed (see FIG. 3). The data administrator then enters a six-digit positive integer, representing the Week data set to be created, into a “Week number” data field 310. The process is completed by clicking a “Create Week” button 320, which sends the input to the server, initiating server-side programs that generate the components comprising the Week data set. This server-side processing is described in detail in the “System Architecture” section below.

The six-digit positive integer provided in the process described above becomes the identifier for the server-side processing of data pertaining to the relevant Week. There is no restriction on the creation time or order of Week data sets. Week data sets are activated on the end-user display sequentially according to their six-digit identifiers (i.e., Week 000002 follows Week 000001). At the end of the one-week time period represented by Week data set N, Week data set N+1 becomes the active data displayed to the end-user. The server administrator specifies the exact time of this rollover. In the preferred embodiment, the data set representing a given one-week period is activated Sunday at 12:01 a.m. local time to the server.

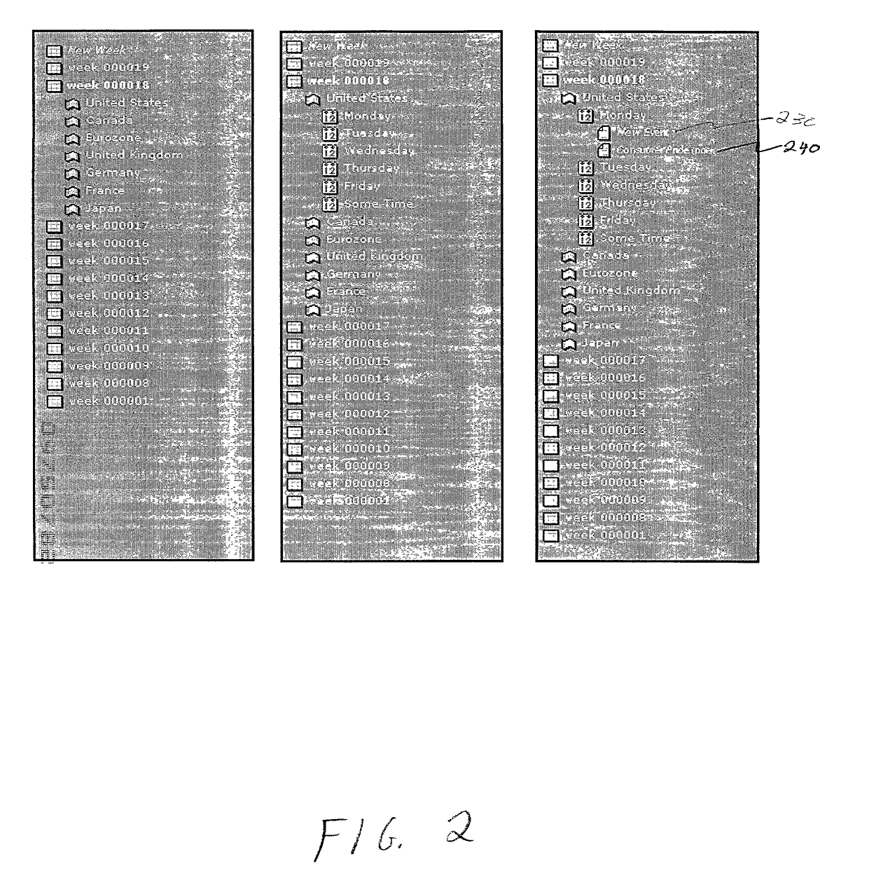

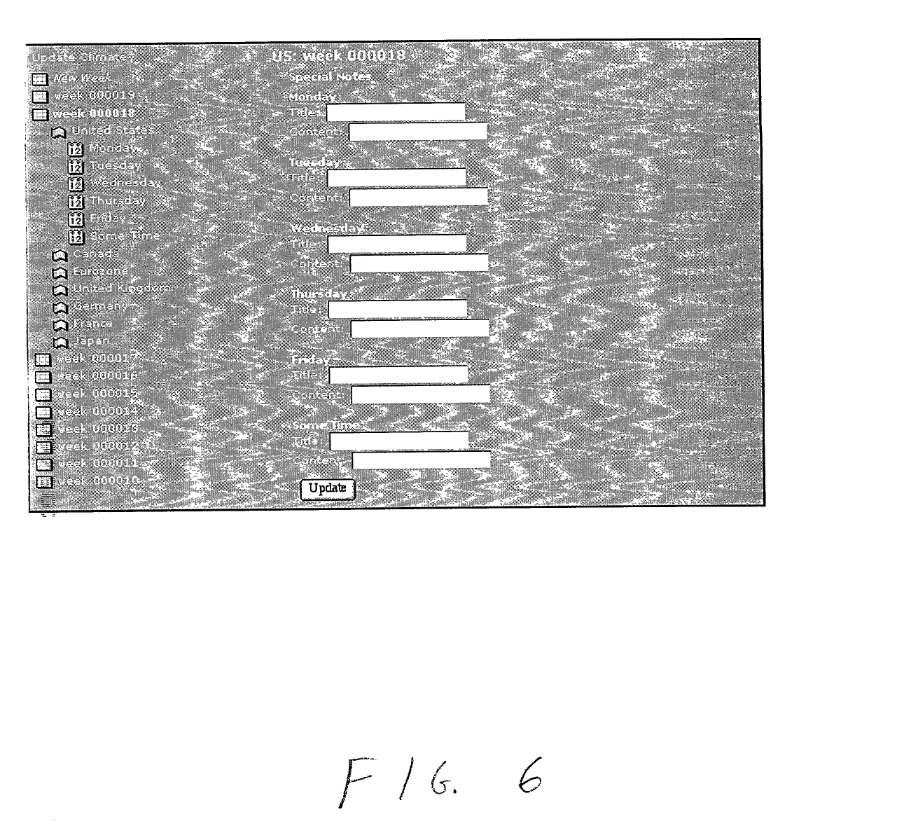

Any existing Week data set is represented on the Control Panel by hypertext and an icon. The hypertext representing the Week data set active on the end-user display is emboldened. In the preferred embodiment, clicking on the hypertext or icon for any current, past, or future Week data set displays for that data set a list of hyperlinks representing Country categories as shown in FIG. 2. This list is similar for all Weeks. Clicking on a certain Country Link A displays a list of links representing Days (i.e., Monday-Friday and Sometime [during the week]). Clicking on Country Link A a second time displays to the right a form (see FIG. 6) for entering “Special Notes” for each day of the week. Special Notes pertain to occurrences that do not require the in-depth information of an event record. A national holiday is an example of the subject of a Special Note. For these Special Notes, the data administrator(s) has the option of entering a “Title” (e.g., Bank Holiday) and brief “Content” (e.g., All markets will be closed). Once the data has been entered, clicking the Update button uploads the data to the server. The server-side processing of this data is described in detail in the “System Architecture” section below. The display of this data to the end-user is described in detail below.

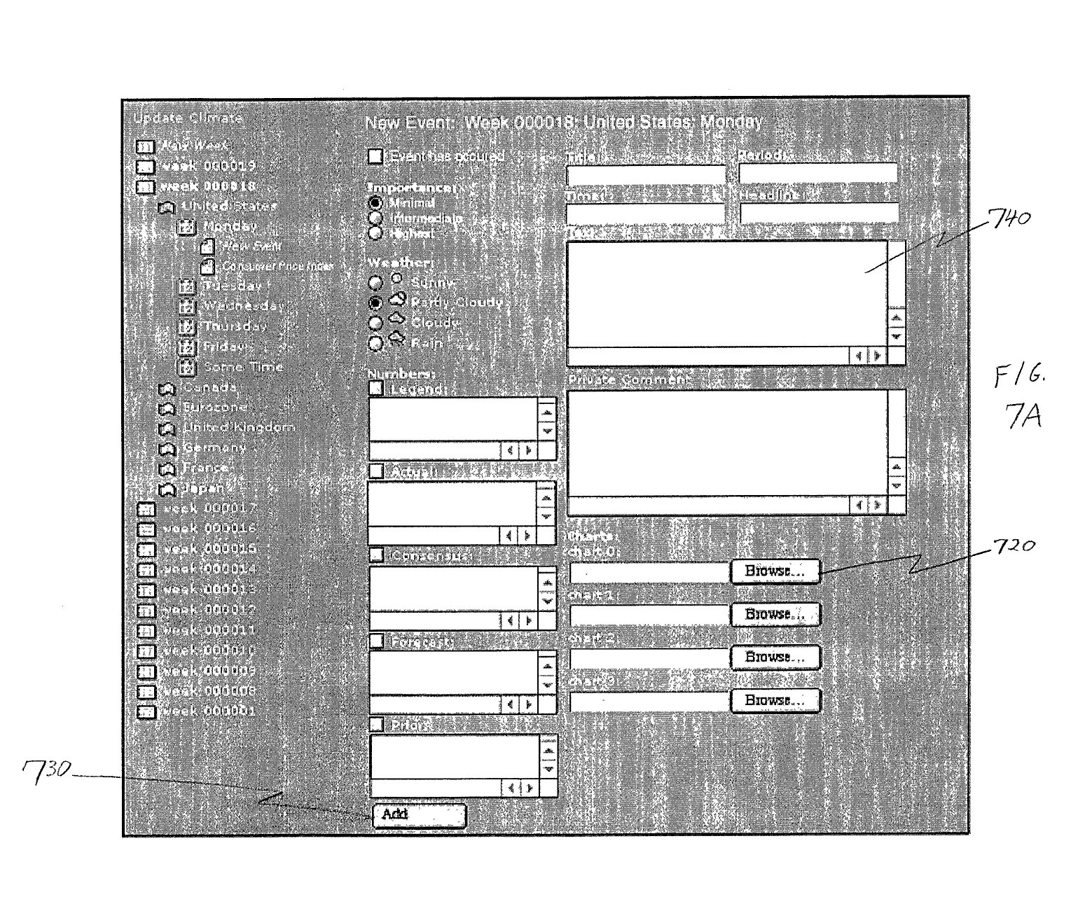

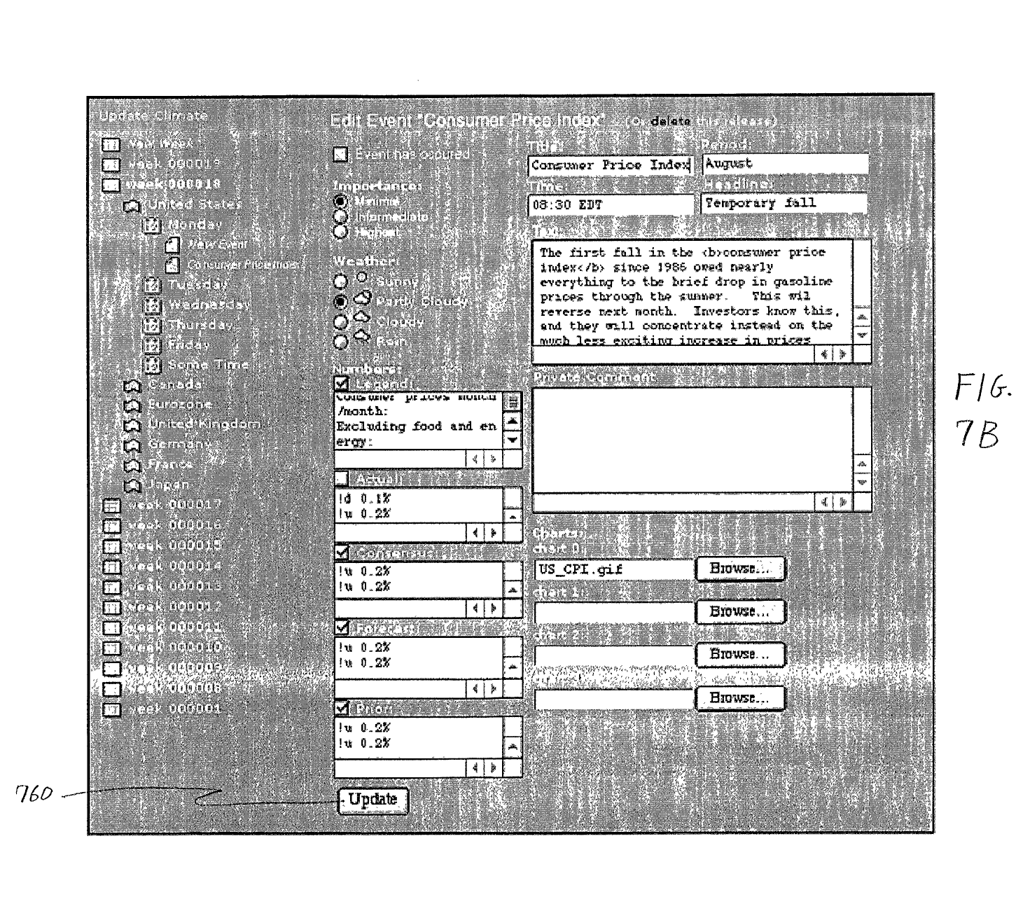

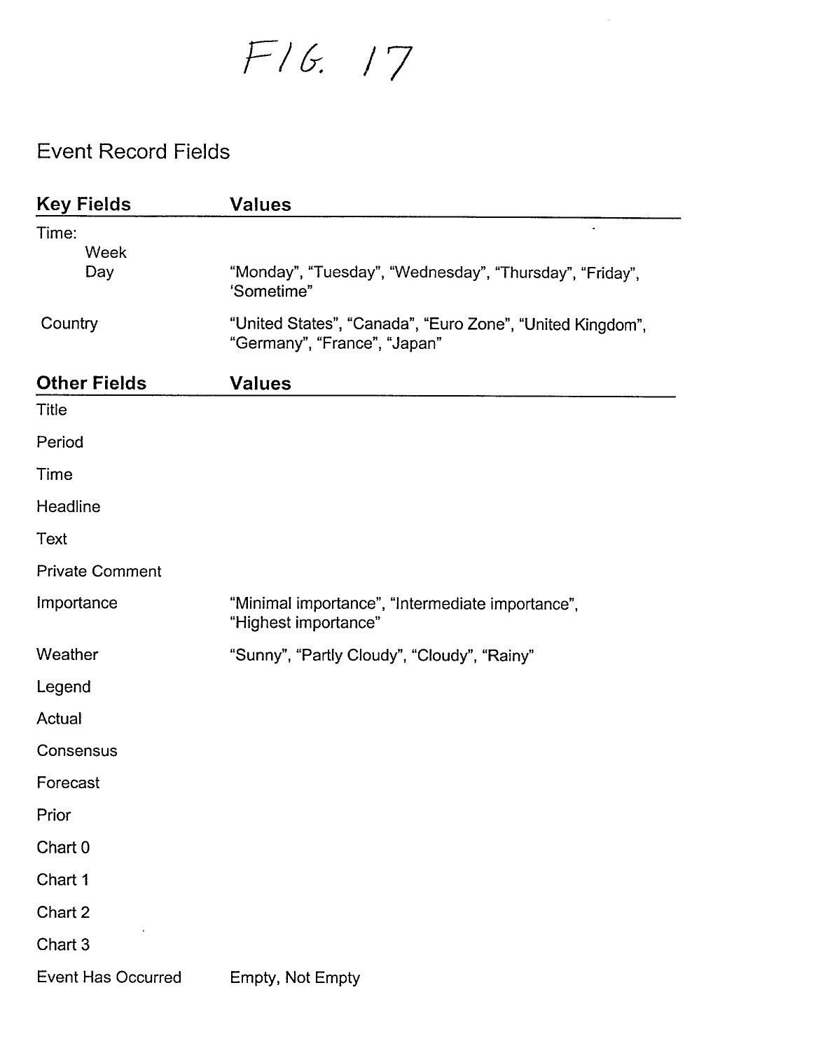

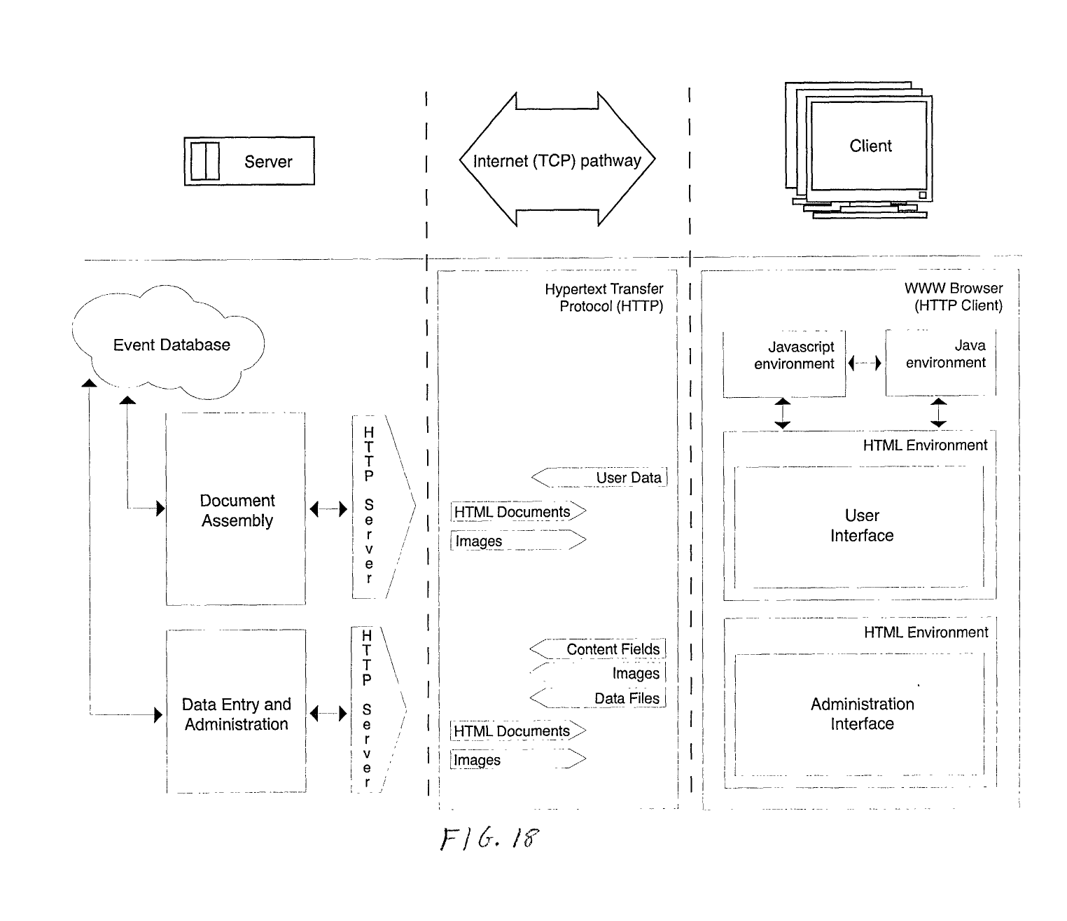

Clicking a Day link (i.e., Monday-Friday and Sometime) displayed under a given Country displays the title of any event records that have already been created, as well as a “New Event” link 230 for creating a new record, as shown in FIG. 2. Clicking the “New Event” link 230 displays to the right fields for entering data, as shown in FIG. 7A. In the preferred embodiment, these fields include those documented in FIGS. 7A, 7B, and 17. Also, the New Event form depicted in FIG. 7A allows a user to upload graphics relevant to the event in question, such as charts or illustrations, in acceptable web formats. In the preferred embodiment, it is possible to upload four distinct graphics for any given record, although this should not be considered a limit on the possible number of graphics that can be uploaded in alternate embodiments. Clicking a “Browse” button 720 for any of the four fields relating to graphics allows a data administrator to browse through file directories on the computer in use, or any files available on mounted servers. Once a graphics file is selected, its name appears in the relevant graphics field. Clicking an “Add” button 730 uploads the selected graphics file(s) as well as the other input data to the server for processing. This server-side processing is described in detail in the “System Architecture” section below. Links representing added event records are immediately displayed at the Control Panel (see FIG. 2).

Clicking a link 240 for a pre-existing record displays to the right a form, shown in FIG. 7B, for editing that record with the fields documented in FIG. 17. The fields displayed in the Edit Event form in FIG. 7B are the same as those displayed in the New Event form in FIG. 7A, except that the fields in FIG. 7B contain data that has previously been entered/edited for that event record. Here, uploaded graphics can be removed or changed, or new graphics can be uploaded according to the process described above. Clicking an “Update Record” button 760 uploads the edited data to the server for processing. This server-side processing is described in detail in the “System Architecture” section below.

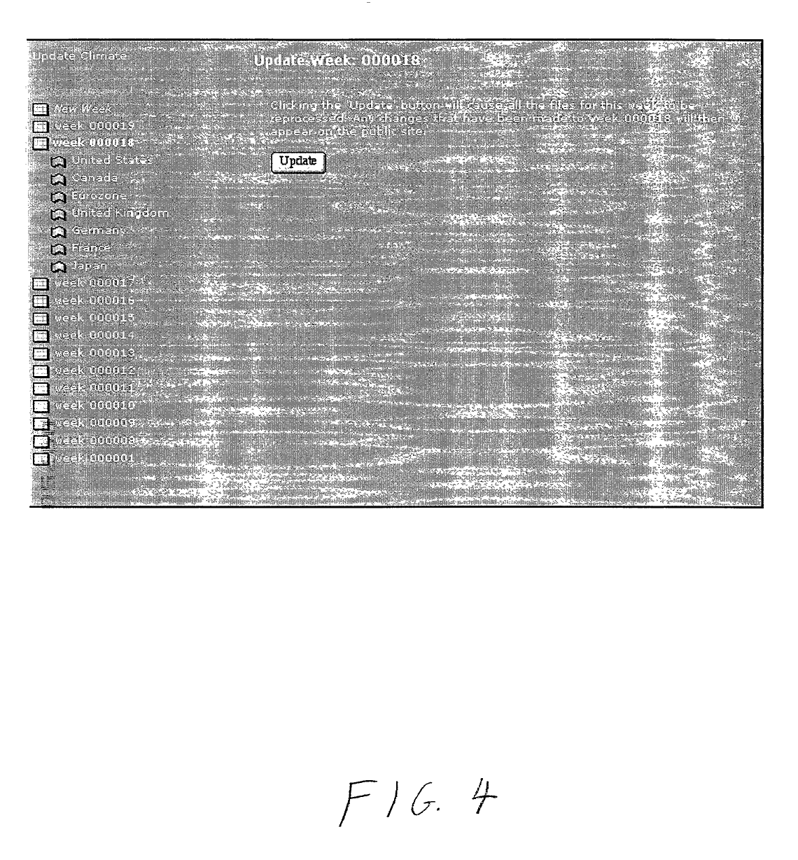

New records (events) for active Week data sets, or changes made to existing records for active Week data sets, can be viewed immediately on the Control Panel. However, these updates are not immediately accessible on the end-user interface. This characteristic allows greater flexibility in content production. To apply data updates to the views displayed on the end-user interface, the data administrator(s) must “Update the Week” from the Control Panel. This is accomplished by clicking the active Week data set icon (in bold) once if the associated Country icons are already displayed, and twice if they are not. A button labeled “Update” is then displayed to the right of the window (see FIG. 4). Clicking this button sends instructions to the server to reprocess the files for the Week so that all data updates are accessible on the end-user interface. This server-side processing is described in detail in the “System Architecture” section below.

The above-described process is also necessary to apply data updates for past, non-active Weeks to the end-user display. While the complete data set for past Weeks may be inactive, certain records may be referenced in active Weeks using links. It is desirable to have the ability to amend any data that can be accessed by end-users.

The above-described process is redundant for future, non-active Weeks, as the files for end-user display are not processed until the Week is made active. This server-side processing is described in detail in the “System Architecture” section below.

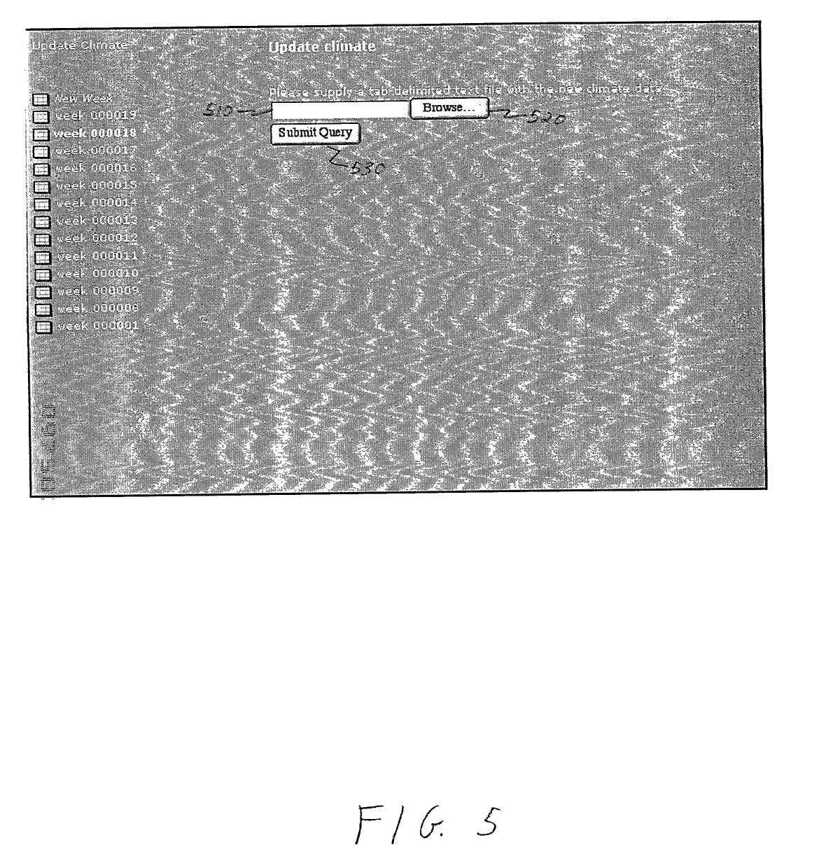

Climate information is also uploaded using the Control Panel interface (see, e.g., FIG. 1B). This is accomplished by first clicking an “Update Climate” link 130. An “Update Climate” page is then displayed (see FIG. 5). An empty text box 510 and a button 520 labeled “Browse” appears to the right. Clicking this button 520 allows a data administrator to browse through file directories on the computer in use, or any files available on mounted servers. Once a file has been selected, clicking a “Submit Query” button 530 uploads the file to the server for processing. The nature of these Climate files and their server-side processing are described in detail in the “System Architecture” section below.

B. End-user interface

A more efficient method of accessing and displaying information pertaining to discrete events, particularly in the financial markets, is an important object of the present invention. The end-user interface is a critical component of the present invention in all its embodiments because it is the means by which data are accessed by and displayed to the end user.

The end-user interface is graphical in nature and is accessed using a standard Web browser. The processes by which the files and programs that constitute the interface are generated, displayed to the end-user and return user input to the server are described in detail in the “System Architecture” section below.

The defining characteristics of the graphical user interface (GUI) in a preferred embodiment are the calendar metaphor; the weather symbols; the navigational system in general, and in particular the functions of the MiniGrid; and the ability to “personalize” the display of certain information.

The graphical elements employed in the GUI and the method of data representation evoke a desktop calendar. While the Web medium is far more flexible in terms of data representation than a two-dimensional desktop calendar, using this familiar object as the metaphor for the GUI provides new users with a reference for making their first inferences about the functionality of the site.

FIG. 8A depicts a Home page for a preferred End-User Interface. A user entering a preferred website is first presented with a display as depicted in FIG. 8A. Highlights of the current day's events are provided. Each topic or headline 830 is hyperlinked to a more extensive discussion of that topic. A Minigrid 810 (also depicted in FIG. 8B, and discussed in more detail immediately below) simultaneously provides a visual summary of and navigational aid to information available on the site.

In a preferred embodiment (see FIG. 8A), a row of six tabs represents weekdays (Monday-Friday and Sometime, the possible values of the Day field). Also in this row (or horizontal axis) is a “Week” tab 840, representing the range of weekdays. A column of eight tabs represents categories of events, including seven “Country” categories and a “Custom” tab, representing a personalized category described in detail below. Also in this column (or vertical axis) is a “World” tab 860, representing the range of Country categories. These graphic tabs mimic the appearance of physical folder or divider tabs. Because the tabs, which constitute the frame of the display, are never obscured in the GUI, it appears as a seamless online application. Providing this consistent metaphor avoids confusion on the part of the user regarding navigation and functionality of the site.

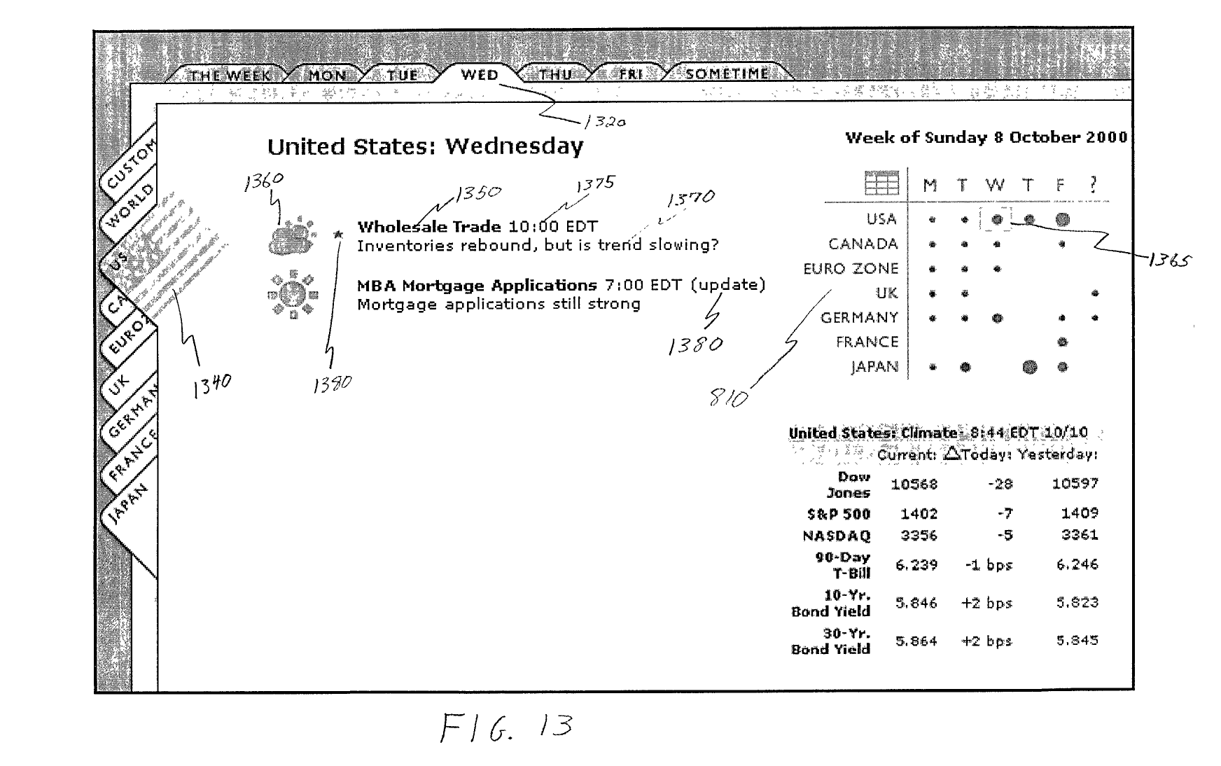

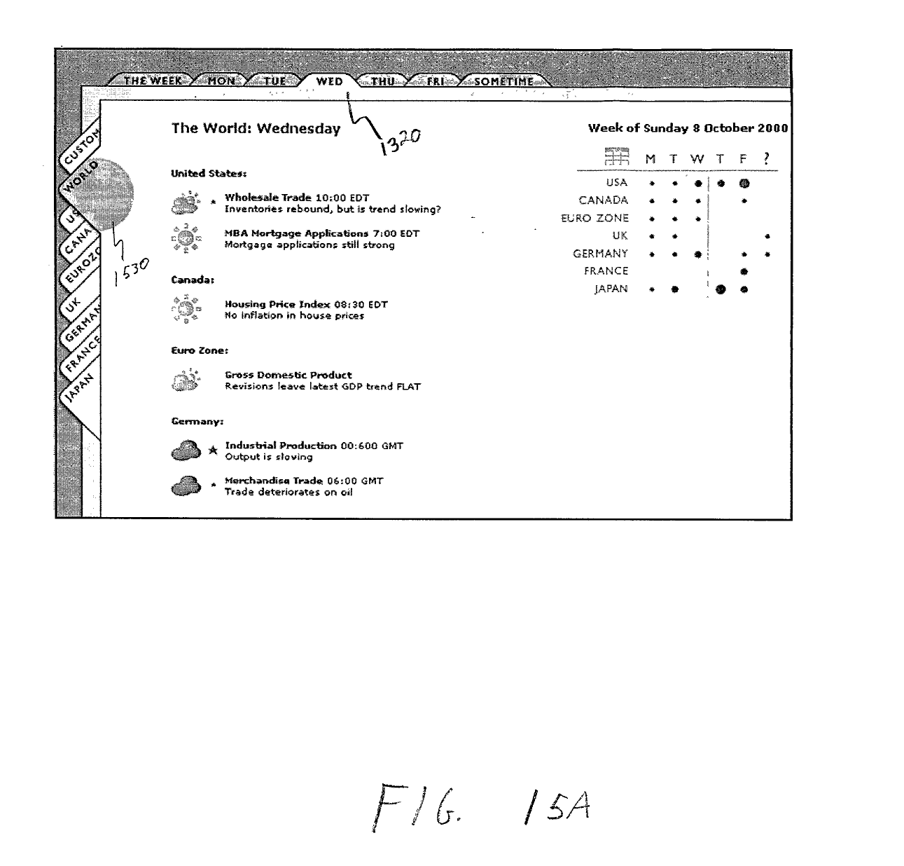

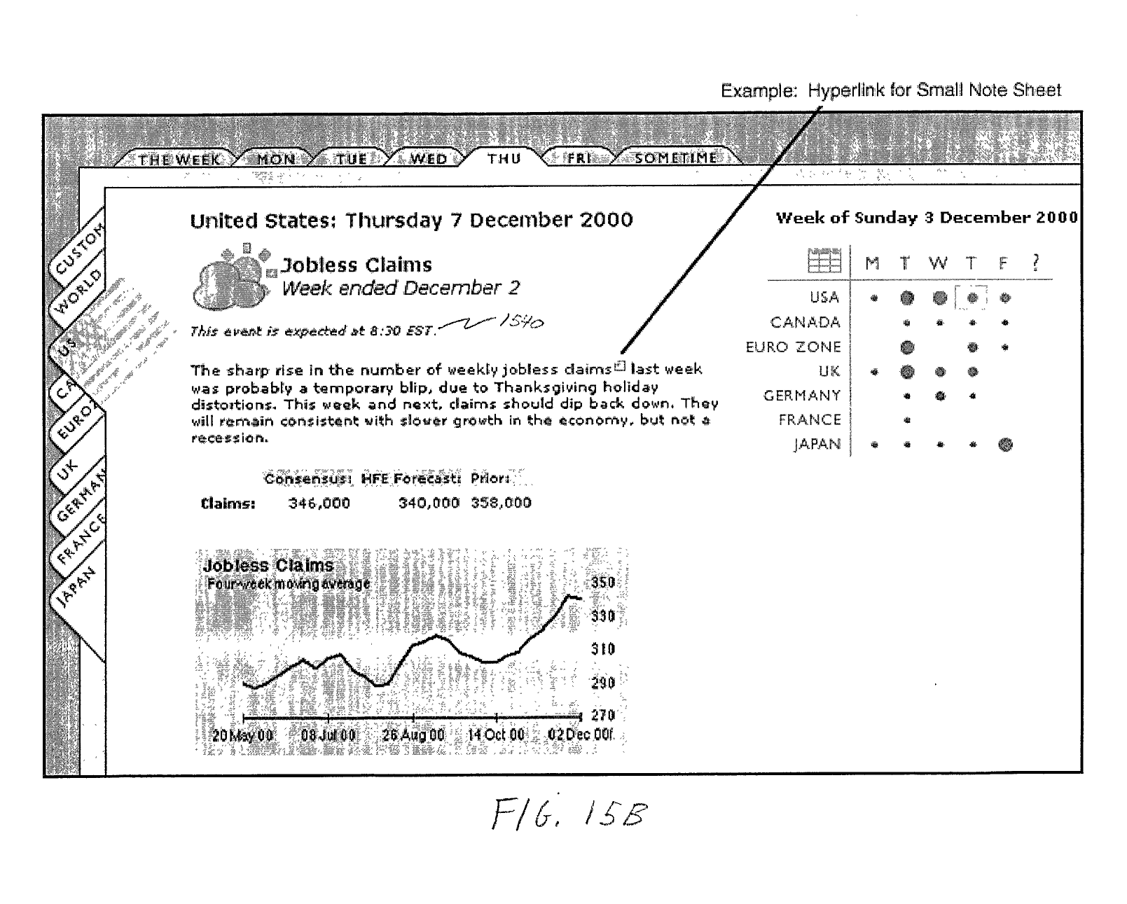

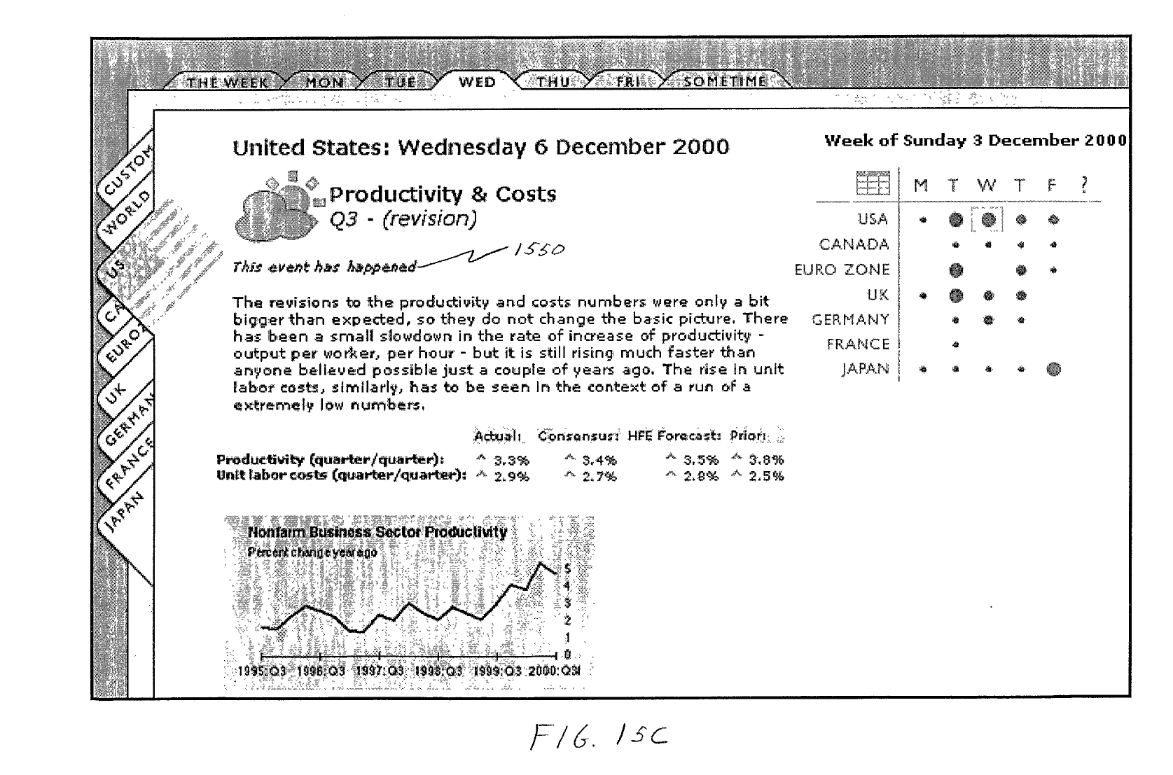

The user infers that the tabs classify information that is accessible on the site—in particular, information concerning discrete events in the real world relevant to the financial markets. At all times, one tab on the horizontal axis and one tab on the vertical axis is in the forward, or active position, as shown, e.g., in FIG. 13. The user infers that the possible combinations of these tabs represent classes of information determined by (a) weekday and (b) country, or a personalized category as described below. For example, in the preferred embodiment (see FIG. 13), when the “Wednesday” tab 1320 and the “United States” tab 1340 are in the forward position, information about events related to the United States occurring on Wednesday will be displayed. Or, referring to FIG. 15A, if the “Wednesday” tab 1320 and the “World” tab 1530 are in the forward position, information about events for all Country categories occurring on Wednesday will be displayed. The use of these tabs to access information and their relationship to displayed information is explained in detail in the “Navigation” section below.

In the preferred embodiment, occasionally some information to be displayed using the GUI cannot be adequately placed within the calendar paradigm using the categories represented by the tabs. This could include enterprise information, instructions for using the GUI and educational information about certain esoteric terms or concepts. “Note Sheets” are used to display this information without disrupting the calendar metaphor of the GUI. In the preferred embodiment, there are two sizes of Note Sheets.

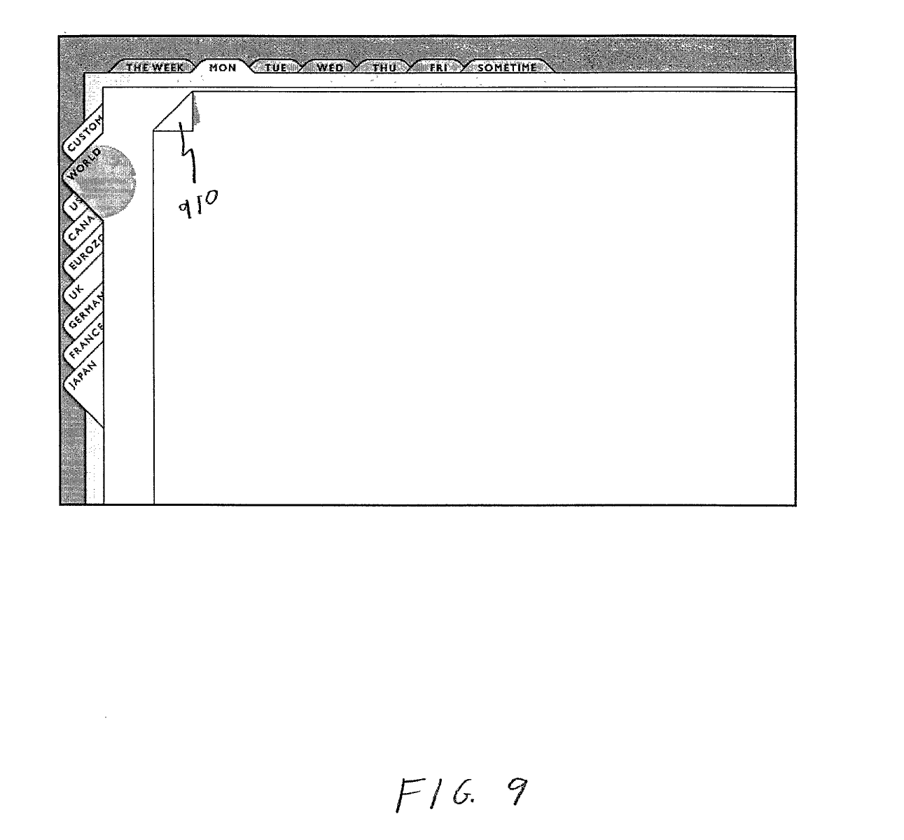

The larger Note Sheets appear to the user as a yellow sheet of paper overlaying the space framed by the horizontal and vertical axes of tabs. As shown in FIG. 9, this “overlay” does not obscure the tabs. The user can “discard” this sheet by clicking on the folded tab graphic 910, or by clicking on any part of the calendar display in view.

One application of the large Note Sheets in the preferred embodiment is the “home page” (see FIG. 8A), which is displayed at the beginning of each user session. In the preferred embodiment, the home Note Sheet provides the user with a brief explanatory introduction to the GUI. In alternate embodiments, it is used to request login information from users for accessing personalized displays or as a means for restricting access to the site to authorized users. In still another embodiment, the home Note Sheet is forgone entirely.

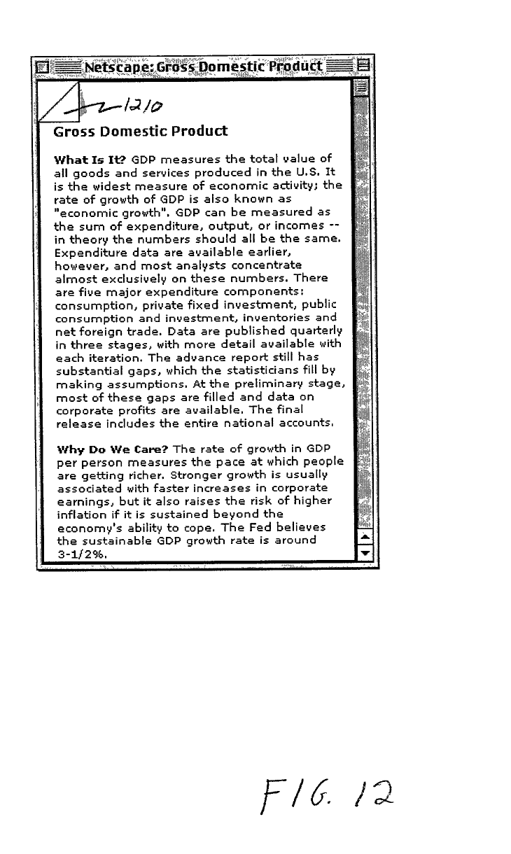

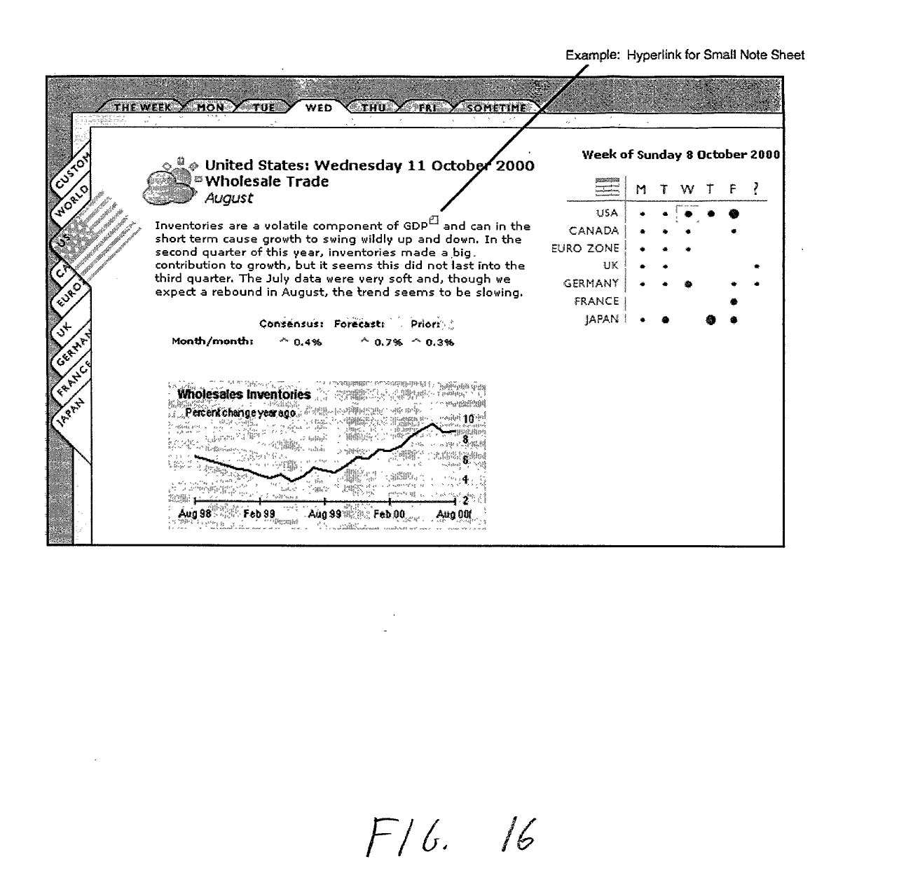

In the preferred embodiment, small Note Sheets convey supplemental information, such as explanations of esoteric concepts introduced in content relating to events. For example, in the Text field 740 (see FIGS. 7A and 7B) of an event record (corresponding to the Text field) the term “GDP” might be used. As shown in FIG. 16, the term is displayed in hypertext and a small icon indicates that a Note Sheet is available. Clicking on either the hypertext or the icon displays the note with the relevant definition of the term. In the preferred embodiment, each small Note Sheet appears as a platform window, as depicted in FIG. 12. These notes can be “discarded” by clicking the folded tab graphic 1210 or by closing the platform window.

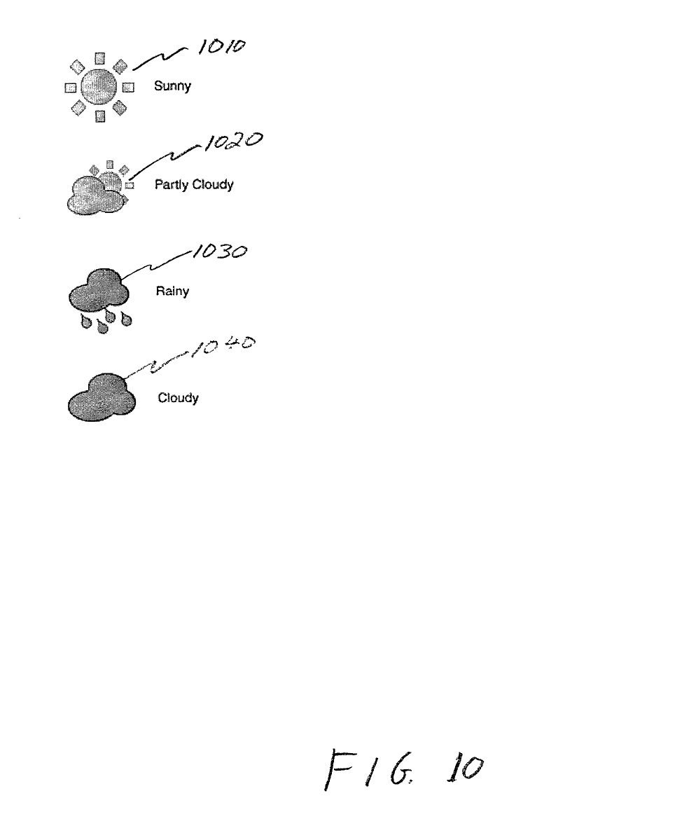

Another characteristic of the GUI in its preferred embodiment is the system of weather-related symbols. In the preferred embodiment, each event is labeled with one of four weather icons: “sunny” 1010, “partly cloudy” 1020, “cloudy” 1040, and “rainy” 1030, as depicted in FIG. 10. These icons provide a quick summary of the information provided by the content of the corresponding event record. Before the actual events have occurred, the weather icons represent a “forecast”—an expectation of the outcome of the event. After the events have occurred, the weather icons provide a representation of the actual outcome of the event. For example, a strong Gross Domestic Product report will receive a “sunny” icon, conveying that the event indicates the economy is healthy. A report of a sharply rising unemployment rate will result in a “rainy” icon, indicating an unfavorable economic development.

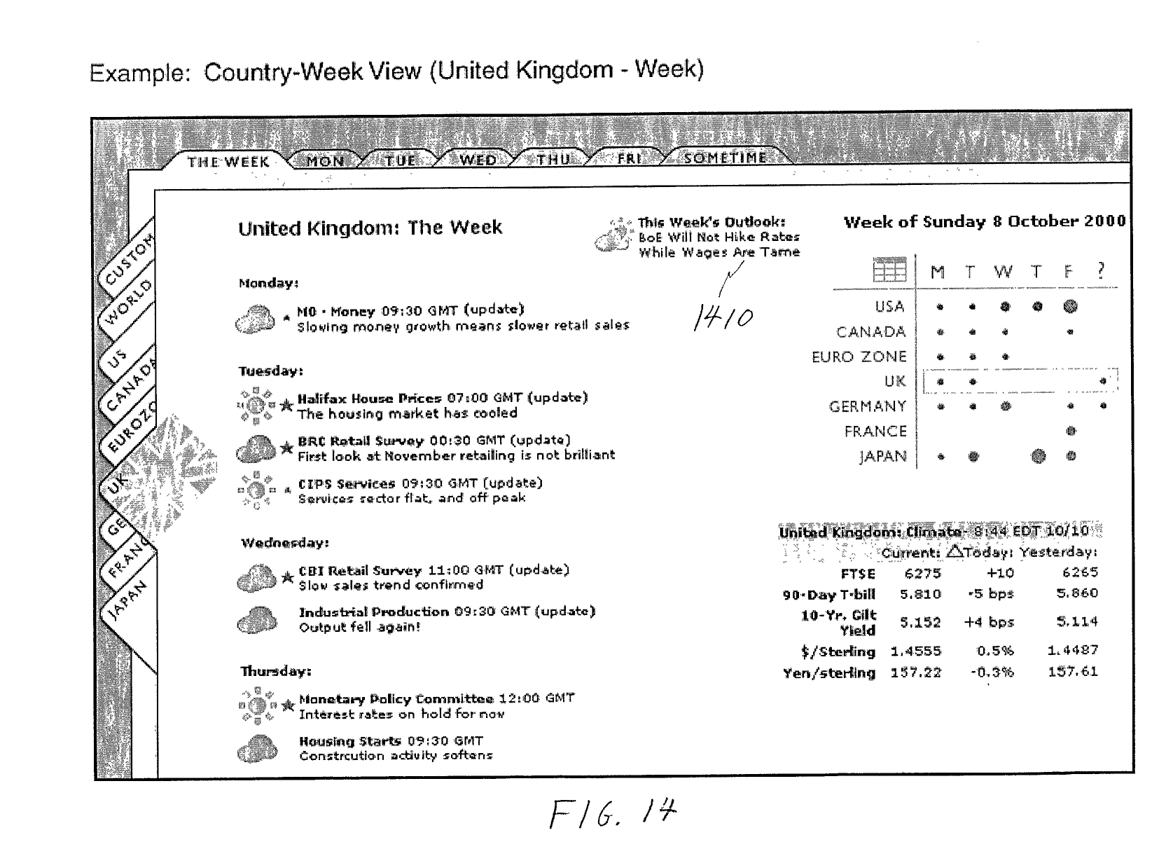

In the preferred embodiment, these icons can also be used to summarize the forecast or actual outcome of a series of events for a given country over a daylong period, a week-long period, or longer. For example, if most of the events in Canada for a given Week indicate that the economy is healthy, the Week is rated with a “sunny” icon. A second example is shown in FIG. 14, where a “partly cloudy” icon 1410 is used to represent the situation in the U.K. for the Week of Sunday Oct. 8, 2000.

Because these symbols are employed consistently, users quickly learn their meanings in the context of the GUI. In alternate embodiments, where the invention is used to display information relating to other subjects, the weather symbols are still employed consistently to convey meaning relevant to the subject in question.

The weather symbolism is reinforced by the “Climate” data displayed using the GUI. In the preferred embodiment, the Climate data consist of background information about relevant countries and their markets. This might include prices and/or yields of benchmark government bonds, stock market indexes or currency exchange rates. Much the way an actual climate provides the context for actual meteorological events, the Climate data of the GUI provide the context for events impacting the financial markets.

The system of weather-related symbols described above both reinforces and extends the calendar metaphor. It is common to associate weather and weather forecasts with specific time periods. Thus, in the context of a calendar metaphor, using weather imagery to describe discrete events and their impact over specific time periods provides users with a familiar way to assimilate a large amount of information that can sometimes be confusing or overwhelming. These tools enhance the value of the information by making it quicker and easier to interpret, thus providing an ergonomic advantage over known interfaces.

MiniGrid and Navigation:

Referring to FIG. 8B, a MiniGrid 810 is the primary instrument for accessing (navigating) data views on the GUI.

The MiniGrid 810 is a graphical representation of the conceptual grid that constitutes the data model of the site. It provides the user with a graphical overview of the distribution of available data and a way to access (navigate) views of that data. It also provides a unified visual context within which to place the active view of the data. Finally, in the preferred embodiment, the MiniGrid functions as the broadest indicator of the actual events that are the subject of the data.

In the preferred embodiment, the MiniGrid 810 is visible at all times in the upper right hand corner of the calendar frame (see FIGS. 8A and 8B). The active MiniGrid 810 corresponds to the active Week data set. Thus, one MiniGrid 810 represents one Week of event records. Six columns of the MiniGrid 810 represent Day categories, as shown in FIG. 8B. The headers for the rows of the MiniGrid 810 constitute an additional column, representing the range of all Day categories (the entire Week). Seven rows of the MiniGrid 810 represent Country categories, as shown in FIG. 8B. The headers for the columns of the MiniGrid 810 constitute an additional row, representing the range of all Country categories (the “World”). The categories implemented in the preferred embodiment should not be considered limiting factors in alternate embodiments.

Because all event records are classified by Time (Week and Day) and Country, any event record can be located in a cell of a MiniGrid 810. An empty cell in the MiniGrid for an active Week data set signifies that no event records exist for the Country-Day category represented by that cell. The existence of one or more event records that fall within a particular Country-Day category is signified by a marker in the cell representing that Country-Day category. In the preferred embodiment, this marker is a circle. A single marker is used to represent multiple event records, such that a larger marker represents more event records. In the preferred embodiment, there are four sizes of markers, with progressively larger sizes representing one additional event record, the largest size representing four or more event records. In an alternate embodiment, additional marker sizes are used; in another, marker sizes are used to indicate a range of event records. For example, Size One corresponds to one to two event records, Size Two corresponds to three to four event records, etc. In yet another embodiment, each event record is represented by a unique marker within the corresponding cell. In a still further embodiment, the number of events in a cell is denoted by a numeral, preferably Arabic: “3” indicates that there are three events in that Country-Day category.

By using colors, the markers also convey information about the importance of the event records they represent. (Importance is defined by the value of the Importance field, see FIGS. 7A, 7B, or 17). In the preferred embodiment, two color distinctions are used. Blue indicates minimal or intermediate importance, and red indicates highest importance. In the case where a single marker represents more than one event record, the marker will be red if at least one event is ranked with the highest importance. In alternate embodiments, three colors are used to signify all three levels of importance. In yet another embodiment, the color of the marker is used to indicate a quality altogether different.

In its capacity for navigation, the MiniGrid 810 represents different data views. Each individual cell, row, and column of the MiniGrid 810, as well as the entire MiniGrid 810 itself, correspond to data views. In the preferred embodiment, an individual cell represents a data view that includes a list of all events that fall within the corresponding Country-Day category. This is referred to as a Country-Day view (see, e.g., FIG. 13). An entire column of the MiniGrid represents a data view that includes a list of all events that fall within the Day category of the given column. This is referred to as a World-Day view (see, e.g., FIG. 15A). An entire row of the MiniGrid represents a data view that includes a list of all the events for the entire Week period that fall within the Country category of the given row. This is referred to as a Country-Week view (see, e.g., FIG. 14). The entire MiniGrid represents a data view consisting of a list of all events for all Country categories for the entire Week period. This is referred to as a World-Week view (see FIG. 8C). The views described above are referred to as summary views, because they provide a summary of a category of event records.

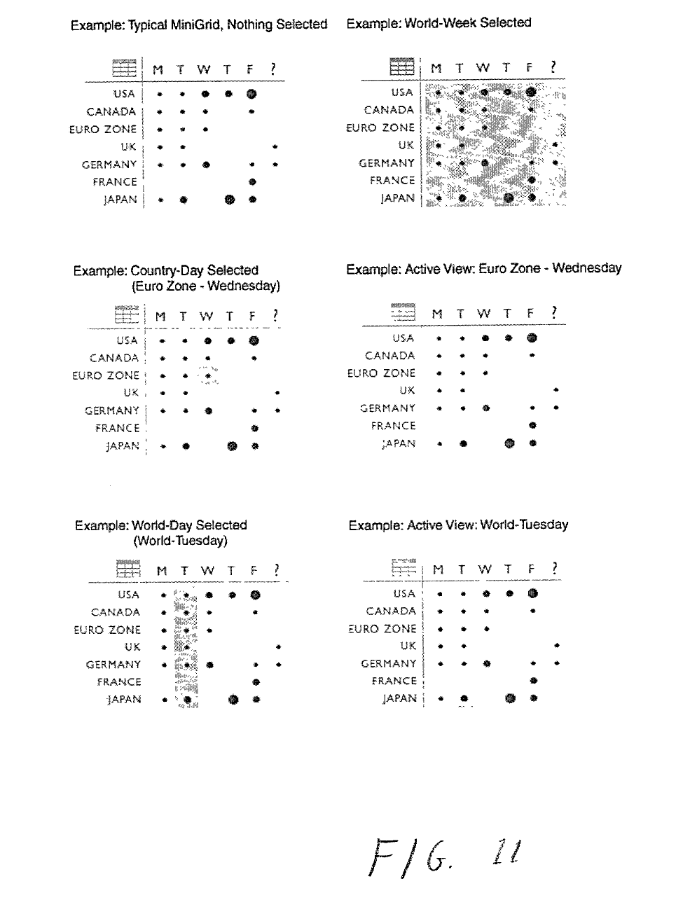

To access the summary views represented by the MiniGrid, a user selects the cell or group of cells representing the desired view. For example, to access the USA-Wednesday view, the user “mouses” (i.e., places the mouse cursor) over the corresponding cell. The cell is instantly highlighted. Clicking the mouse while the cell is highlighted displays the corresponding view to the left (see FIG. 13). An entire column or row is selected by mousing over the header for that column or row (see FIGS. 11, 14, and 15A). For example, mousing over the “W” (Wednesday) header highlights the entire Wednesday column. If the mouse is clicked, the corresponding data view appears to the left (see FIG. 15A). The entire MiniGrid 810 can be selected by mousing over the icon 820 (see FIG. 8B) in the upper left-hand comer of the MiniGrid 810. This displays the World-Week view (see FIG. 8C).

In the preferred embodiment, all views described above, with the exception of the World-Week view, display the following information—derived from the event record fields shown in FIG. 7A—for each event listed (see, e.g., FIG. 13): event title 1350, weather icon 1360, headline text 1370, time of release 1375, importance 1380, and an indication 1380 of whether the event has occurred (“(update)”).

Event record displays preferably provide the following information: event title; weather icon; time of release (or an indication that the event has occurred, if that is the case); textual analysis; and information (e.g., an illustrative chart or numeric statistics) relating to the event. Event record displays for events that have already occurred (see FIG. 15C) do not provide predictions—they provide reports of what occurred. To alert users to the nature of the event record, an indication 1550 is preferably displayed that indicates that the event is a past event. To further alert users to temporal circumstances, event record displays for events that have not yet occurred (see FIG. 15B) preferably comprise an indicator 1540 that indicates that the event is a future event.

The World-Week view shown in FIG. 8C displays only the event titles and small weather icons, for reasons of space and functionality. The World-Week view is meant to serve as a broad overview of the events for the Week, while the other summary views are meant to provide a slightly more detailed perspective of events, while still facilitating their contextualization.

In the preferred embodiment, event records are accessed through the summary views described above, so long as the view displayed represents a category for which there are corresponding event records (i.e., at least one of the cells selected in the MiniGrid is not empty). All event titles listed in summary views are in hypertext; clicking them will display the corresponding event record. Accessing event records through summary views helps the user to contextualize the event.

In the preferred embodiment, event records (see, e.g., FIGS. 15B & 15C) cannot be accessed directly from the MiniGrid. This is primarily because event records are not uniquely represented in the MiniGrid. This is not a technical limitation of the invention, however. In an alternate embodiment, each event record is represented by a unique marker in the MiniGrid. In this embodiment, clicking on a marker displays the corresponding event record; this embodiment is not preferred because it could lead to greater user error if the markers are small and difficult to select.

While event records are preferably not directly accessible via the MiniGrid, the MiniGrid facilitates access to any event record for the active Week using only two clicks. This is true because the MiniGrid allows direct access to any summary view with one click, regardless of the current active view, and all event records can be accessed from a corresponding summary view.

The horizontal and vertical axes of tabs described above are a secondary instrument for navigating data views. The horizontal and vertical axes of tabs correspond, respectively, to the columns and rows of the MiniGrid—with the exception of the Custom tab, described in detail below. One tab from each axis (horizontal and vertical) is always in the forward, active position. Tabs are brought to the forward, active position by clicking them with a mouse. The combination of active tabs determines the view. For example, when the US and Wednesday tabs are clicked into the forward, active position, the displayed view (see FIG. 13) includes a list of all events that correspond to the US category and fall on Wednesday. The possible combination of tabs on the horizontal and vertical axes (with the exception of the Custom tab) allow access to the same views that can be accessed using the MiniGrid

Because only one tab can be clicked at a time, owing to the fact that there is only one active cursor, accessing summary views using the tabs can sometimes require two clicks. For example, switching from the US-Monday view to the Japan-Monday view using the tabs as the navigation instrument requires just one click on the Japan tab. However, switching from the US-Monday view to the Canada-Tuesday would require two clicks using the tabs as the navigation instrument. The Tuesday and Canada tabs may be clicked in any order in this example. If the Canada tab is clicked first, the intermediate view will be Canada-Monday. If Tuesday tab is clicked first, the intermediate view will be USA-Tuesday. Alternatively, the MiniGrid could be used to make the switch from the US-Monday view to the Canada-Tuesday view using just one click—on the MiniGrid cell representing Canada-Tuesday.

For reasons evident in the example above, the MiniGrid is a more efficient navigation mechanism than the tabs. But together, the MiniGrid and tabs complement each other and form a more sophisticated navigational system. One aspect of this system is that it allows navigation from the left and right sides of the browser window. For example, some users may find they prefer to browse data views using the MiniGrid. However, such users may also find that they use the tabs to navigate at times when their cursor is already to the left side of the browser window. This saves the user the time of moving his or her cursor to the opposite side of the window. To those familiar with web browsing habits, this will be recognized as a valuable time-saving feature. Also, depending on factors such as the user's knowledge of the information available, either the tabs or the MiniGrid may seem like a more logical navigation instrument. For example, a user less knowledgeable about the financial markets may feel more comfortable using the familiar-looking tabs, which relate more closely to the calendar paradigm. Alternately, an individual more knowledgeable in the field, one who knows exactly what information he or she is seeking, may find that the MiniGrid is better suited to their needs and allows more precise navigation.

Regardless of whether a tab or the MiniGrid or some combination is used to navigate, both the tabs and MiniGrid always indicate the active view. Even if the MiniGrid is used to select a view, the tabs will automatically adjust to display the combination of horizontal and vertical tabs that correspond to the view. Similarly, regardless of whether the MiniGrid or tabs are used to select a view, the MiniGrid indicates the active view by outlining the representative cells on the MiniGrid. For example, if the World-Thursday view is active, the entire column of cells under the “Thursday” heading will be outlined and the World and Thursday tabs will be in the forward, active position. When a user is viewing an event record, the narrowest category to which the event record belongs is indicated by the MiniGrid and tabs. This is typically the Country-Day category; the individual cell corresponding to the Country-Day category of the event record is outlined on the Minigrid, and the corresponding Country and Day tabs are in the forward, active position (see FIG. 11). This is true even if the event record is accessed through a broader summary view, like Country-World. Showing the narrowest category to which an event record belongs helps to contextualize the event record being viewed.

Thus far, the MiniGrid has been described as a navigation instrument and as a unified visual context within which to place the active view of the data. The MiniGrid also has a broader informational application. The MiniGrid provides the most generalized overview not only of the data available to users at the site, but the actual events to which the data pertain. For example, in the preferred embodiment, a user could quickly glance at the MiniGrid and determine that it will be a very active Week for economic events in the United States, whereas France will see less activity. This is information that pertains not only to the data of the site, but to actual events in the real world.

In summary, the grid functions as a navigation tool that allows users much more freedom of access and control over their web browsing experience than one currently finds on the World Wide Web. It has capabilities for information representation and accessing (navigating) information, and it acts as a broad indicator of actual, real world events.

Navigating Non-Active Week Data Sets:

In an alternative embodiment, the GUI offers the ability to navigate data from previous Weeks. An example of how this is accommodated follows:

The user initially is presented with the interface in its “standard” form (as described above), with the addition of a device to allow selection of any previous Week (e.g., a drop-down list or a calendar graphic with each Week represented as a hyperlink).

Once a previous Week has been selected, the interface elements (tabs, MiniGrid etc.) behave as though the selected past Week were the current Week. To avoid confusion while viewing previous Weeks, the selected Week is prominently displayed at all times. An alternate visual cue is the use of a different background color for all interface elements while a previous Week is being viewed.

In a further alternative embodiment, the ability to navigate previous Weeks is not provided, but there is a mechanism to display previous event records via hyperlinks from event records in the current Week. These event records, again, are indicated by a different background color. This allows previous Weeks' event records to be provided as background information.

Personalization:

One characteristic of the invention is the ability to personalize certain data views. In a preferred embodiment, a user can create a category that filters event records by Importance and Country category. The resulting Custom category falls on the vertical axis of the conceptual grid. It is similar to the World category in that it consists of an assortment of user-selected Country categories. (“The World” consists of the range of all Country categories).

In a preferred embodiment, custom views are accessed using the Custom tab in the vertical axis. In the preferred embodiment, the Custom category is not represented in the MiniGrid. This is in part due to the fact that the assortment of user-selected Country categories in the Custom category is essentially arbitrary, so the corresponding markers would not be analogous in character to the other Country-Day markers, which relate to discrete categories of events in the real world. However, in alternate embodiments, particularly those in which each event record has a corresponding unique marker in the MiniGrid, the Custom category is included as an additional row on the MiniGrid. There are no technical limitations in any embodiment that prohibit the inclusion of the Custom category in the MiniGrid.

In the preferred embodiment, the user creates custom settings by completing a form that can be accessed through a Note Sheet (described above). The user supplies information for authentication purposes (e.g., a username and password) and selects the Country categories to be included in the custom view. For each Country category selected, the user indicates whether he or she wishes to include events of the highest importance only, both high and medium importance only, or all events, regardless of importance. The user can access a form to change these preferences by clicking a link that appears in each of the Custom views. The storing and processing of these preferences is described below in the “System Architecture” section.

The Custom views are similar to other summary views in terms of the level of information included for each event. The Custom-Week view is similar to the World-Week view with the exception that the only Country categories listed are those previously chosen by the user. Within these chosen Country categories, events are filtered by Importance. The Custom-Day view is similar to a Country-Day view with the exception that events—with the preferred importance values—are displayed for all Country categories chosen, and grouped by said Country categories. In the preferred embodiment, event record views are not affected by the personalization feature.

### III. System Architecture

A. Overview

In a preferred embodiment, the system consists of one or more servers 150 connected to a network 160. Any number of clients 180 may connect to the server via the network. Each client system is associated, at any one time, with a single user. See FIG. 1A.

At this broad level, alternative embodiments include a “standalone” embodiment, in which a single computer contains the functionality of both server and client and there is no network component; and a “client-only” embodiment where all of the functionality except for the storage of event data is contained in the client system. In the latter embodiment, the server can be any system that can accommodate the data storage requirements of the system (e.g., a general-purpose file server using a standard protocol such as FTP, CIFS/SMB, AppleShare, or NFS).

B. Network

Communication between the clients 180 and the server 150 is accomplished by a network 160. In a preferred embodiment, this network 160 is an internet as specified in the Internet Engineering Task Force's standard number 5 (RFC 791) and subsequent documents. In common usage, such a network is called “an internet” or “the Internet.” In a preferred embodiment, all transactions over the network are carried out using the Hypertext Transfer Protocol (HTTP), defined by the World Wide Web Consortium. The general form of any transaction is as follows: (1) the client initiates a Transmission Control Protocol (TCP) connection to the server and identifies the HTTP transaction to take place; (2) if the transaction involves data being sent to the server, the client sends that data; (3) the server sends back whatever data is appropriate to the transaction; and (4) once the transaction is complete, the server closes the TCP connection.

In each transaction, the client provides the server with the name of an object. This name may refer to a particular file (e.g., an HTML document or image file) that the client wishes to retrieve, or it may specify a particular task that is to be carried out by the server. In the latter case, the client may also transmit data that is relevant to the requested task. For example, a request for the server to record a new event would be accompanied by the details of that event.

The existing HTTP protocol does not provide a mechanism to identify a series of transactions as being interrelated. To provide this capability, the HTTP protocol is extended as follows: At the beginning of a user's session, the client generates a random number (state ID) such that this state ID is likely to be unique among all the clients currently using the server. This is achieved by choosing a random number from a range that greatly exceeds the expected maximum number of simultaneous connections. The client then attaches the chosen state ID to all subsequent HTTP transactions. Whenever the server processes a client request, it is thus able to identify the client by the combination of the state ID and the network address of the client. The network address alone is inadequate for this purpose because more than one client may share a single address. The state ID alone is not used because this would allow an invalid client to impersonate a valid client and gain unauthorized access to restricted information.

C. Client

Users see the system as a graphical user interface (GUI) that provides the ability to display, and navigate among, a set of data views and event records. An event record is any set of text, data, charts, or other media that pertain to a discrete event in the real world. The elements that constitute an event record are discussed in greater detail above.

In a preferred embodiment, the GUI is implemented in Hypertext Markup Language (HTML), an ad hoc standard largely formalized by the World Wide Web Consortium. The HTML code defining the interface is executed by an HTML client, or web browser, such as Netscape Communications's Communicator or Microsoft's Internet Explorer.

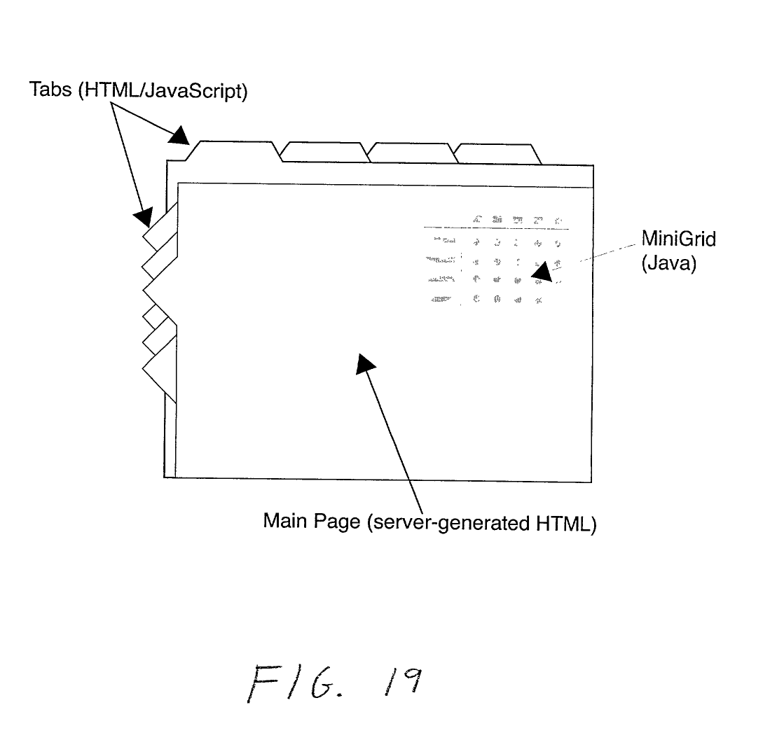

HTML is used to specify the layout of text and images in the interface, to instruct the browser to retrieve necessary objects from the server, to define forms for the submission of information to the server, to load and execute relevant JavaScript and Java code as appropriate, and to define hyperlinks. FIG. 19 shows how elements of the GUI are implemented in these three languages.

The JavaScript programming language is used to implement special behaviors in the client; specifically, to extend the standard behavior of HTML documents and to handle the application-specific (non-HTTP) aspects of the client's communication with the server.

The preferred embodiment also uses the Java programming language to extend the functionality of the HTML interface.

Both Java and JavaScript are executed by interpreters integrated into the majority of current browsers. The decision to use a particular language for a given purpose is determined by the collective limitations of contemporary browsers. For instance, support for manipulating HTML documents from a Java program currently varies widely between browser implementations, so JavaScript is used for this purpose instead of Java.

In all cases, when the user clicks a hyperlink in the GUI, a JavaScript function is executed that (1) makes the appropriate request to the server, and (2) updates the HTML document to implement user feedback. For instance, if the user clicks a hyperlink for an event record, the relevant JavaScript function requests that the server send an HTML document representing the event record, and then updates the MiniGrid and calendar tabs to reflect the Day and Country categories of the event. This is in contrast to a typical web page, where the browser itself is wholly responsible for responding to a link.

Whenever the user switches views, the Java program (applet) that implements the MiniGrid is reloaded as its parent HTML document is replaced with a new document that also contains the MiniGrid applet. At this time, the applet alters its appearance to reflect the currently selected view. The MiniGrid applet obtains the current view parameters from the HTML document within which it appears, using a syntax that is part of the HTML and Java specifications.

The appearance of the MiniGrid is preferably determined not by the MiniGrid applet, but by bitmapped images supplied by the server in the CompuServe GIF format. The server generates two such images for each Week data set: one highlighted image and a corresponding non-highlighted image. Both images are drawn to show the appropriate distribution of events for the Week, as discussed above in the User Interface section. When the user “mouses over” a particular section of the MiniGrid, the applet causes that section to appear highlighted by painting the appropriate rectangular region with the pixels of the highlighted image, while using the pixels from the non-highlighted image to paint the rest of the MiniGrid. Similarly, the applet draws a rectangle to indicate the presently selected view. The reasons for making the server, rather than the client, responsible for most of the calculation involved in drawing the grid are several: (1) the overall computation is greatly reduced since the drawing takes place only when the relevant data is changed; (2) the computation required of the client is reduced; and (3) the interface appears more responsive to the user since most of the drawing has already taken place by the time the MiniGrid is loaded or reloaded.

In an alternative embodiment, the entire client subsystem is written in a single language. For instance, the whole client can be implemented as a Java application, able to run on a variety of computer systems. Alternately, the client can be written in machine language, with multiple versions adapted to run on different types of computers. In any case, the elimination of the web browser would introduce a range of alternative methods for communication with the server (other than HTTP with HTML). Examples include SOAP, RPC, XML with HTTP, and SQL.

In another alternative embodiment, a “thin” client is used. In this type of client/server architecture, all processing is done on the server, and the client system simply acts as a remote monitor, keyboard, and mouse. Several systems exist that support this design, including Microsoft's Windows NT Terminal Server and Citrix's WinFrame.

The administrative site (as distinct from the user site described above) is a simple web site—the interface is written purely in HTML. Links are provided that allow an administrator to select any existing event, calling up an HTML form that allows the elements of that item to be edited and submitted back to the server. Links are also provided to create new events, and to initiate various other server functions via CGI (see below).

D. Server

In a preferred embodiment, the server consists of a standard HTTP server (such as those published by the Apache Software Foundation and the National Center for Supercomputing Applications), integrated with custom software. This integration is achieved through the Common Gateway Interface (CGI) standard, which is supported by most HTTP servers. Alternative modes of integration include Fast CGI or one of the proprietary modes supported by HTTP servers such as Microsoft's IIS or Lotus's Domino.

In the CGI model, custom software is invoked by sending an HTTP request for a document name that the HTTP server regards as “special.” Instead of interpreting this name as a document to be loaded and sent, the HTTP server treats it as the name of a program to be executed, and the object sent back to the client is then the output of that program.

In a preferred embodiment, the custom elements of the server are written in the Perl language. Alternative embodiments use compiled code (machine language), Python, JavaScript, PHP, or another language.

In a preferred embodiment, there are two independent HTTP servers, though this distinction is not of fundamental significance, since the HTTP protocol is stateless—that is, no HTTP transaction affects any other transaction. One HTTP server handles requests pertaining to the main (user) interface, and a second HTTP server maintains the administrative interface.

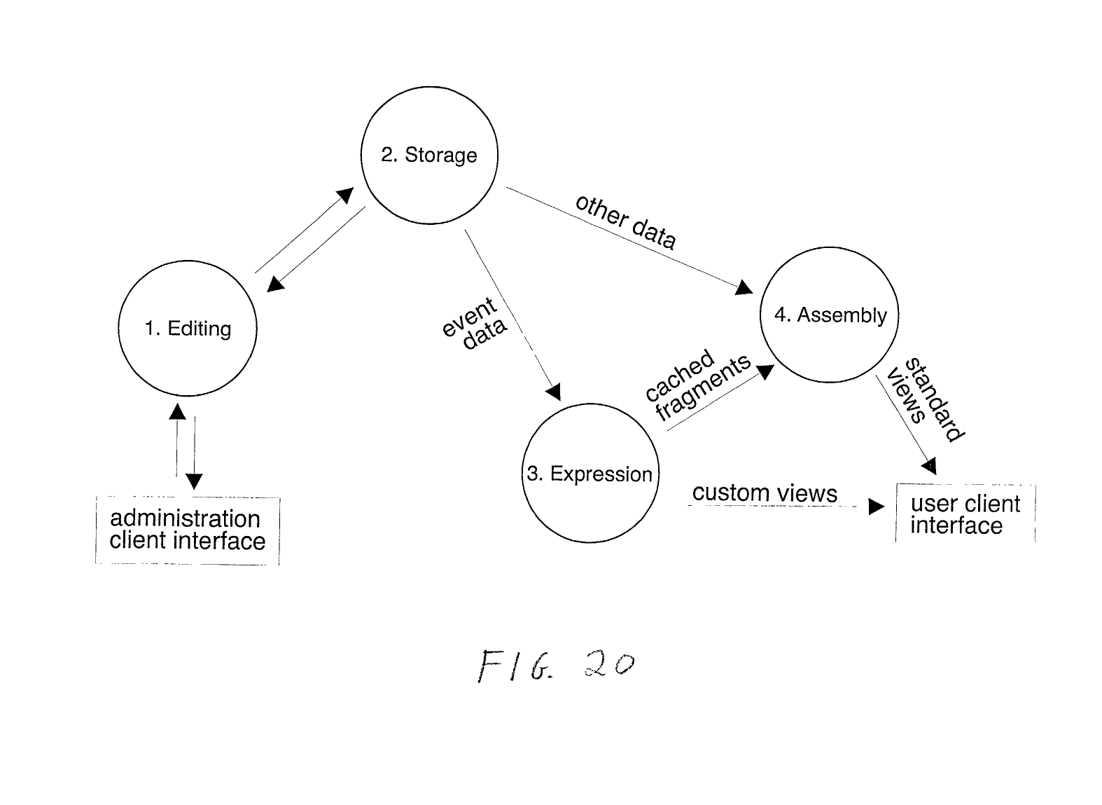

In the server context, event data pass through four distinct phases (see FIG. 20):

1. Editing: Data are input (and possibly edited at a later time) through HTML forms. The server creates an HTML document with instructions to the (administrator's) web browser to request the content of particular fields from the user, and to return the completed fields to the server.

2. Storage: Data are stored in a simple custom database system that allows them to be moved easily into either the editing or the expression phase. An alternative embodiment uses a relational database management system for data storage (e.g., Oracle, IBM DB2, Microsoft SQL server, or MySQL).

3. Expression: HTML code is generated from the stored data for presentation to the user. The actual HTML generated is determined by (a) the purpose for which it is destined (i.e., the template being used—see below), and (b) the underlying data. In some cases, the HTML generated is a fragment of a document, rather than a complete document.

4. Assembly and display: In response to a specific client request, the server assembles the appropriate HTML fragments (if necessary) to form a complete document, and transmits that document to the client.

The reason for separating steps 3 and 4 is that the server preferably caches the generated HTML to improve response times and reduce overall workload. That is, the HTML to service a client request is generally prepared before the request is ever made, a mechanism analogous to short-order food service.

This caching is used in the preferred embodiment for three reasons. First, the number of possible views (and thus the number of HTML documents needed to represent those views) is relatively small (˜10³) compared to the rate at which client requests arrive; second, the data are expected to be updated relatively infrequently; and finally, on computer systems storage space is a far less restricted resource than processing time. Caching makes inefficient use of storage (by storing largely redundant information), but efficient use of processing time (by avoiding task repetition). Between changes to the data set, the number of client requests will generally far exceed the number of possible views. Since it can be confidently predicted that the same view will be requested many times, caching avoids repeated generation of the same document.

Custom views (where the view is determined by an individual user's personal settings) are preferably not cached; when a custom view is required by a client, the HTML is generated at the time of the request (stages 3 and 4 occur as a single stage). The main reason for not caching these views is that no one custom view is expected to be requested frequently.

As described in the “Network” section above, the server maintains a record of active clients. In addition to this, a mechanism is provided whereby a client session can be associated with an existing user account upon provision, by the user, of a username and password. This allows information about the user to be saved and then retrieved in a later session. In this way, users may configure “custom views,” which select events according to user-defined criteria beyond the predefined categories. For these custom views, caching is not generally worthwhile, so the relevant HTML is generated at the time the client request is made.

In some views, the HTML sent to the client includes volatile “Climate” data that are not part of the event database. For performance reasons, the HTML code fragments to display these volatile data are generated separately, and combined with the appropriate fragments whenever a request is made. This approach avoids the cost of reprocessing the event database whenever the climate data change. Combining HTML fragments is a much faster process than regenerating HTML from the database.

All user requests for event data are directed initially to a single “dispatcher” program. This program serves several purposes: (1) it decodes the request to determine what needs to be done to execute it; (2) it notes the state ID of the client making the request, and determines whether that client is authorized to access the requested information; (3) if the requested view is cached, it retrieves the cached HTML; (4) if appropriate to the requested view, it assembles the necessary HTML fragments; and (5) if a custom view was requested, it generates the HTML to represent that view.

Other requests from the user site fall into two categories: (a) “ordinary” HTTP requests (e.g., for decorative images and static HTML pages)—these are handled by the HTTP server without the participation of the custom software; and (b) requests for HTML forms related to customization (e.g., the form to enter a password or the form to change a user's preferences). The latter are handled by separate programs that generate the required forms and, where appropriate, fill in the form fields with current or default values before sending the form to the client.

Requests from the administrative site are all directed to specific programs on the server. For each type of form presented on the administrative site, there is a corresponding specialized program that deals with the data returned by that form. For instance, the form to create or edit an event record is submitted to a program that decodes the data on the form and adds the event record to the database.

The administrative site also includes a “navigation” page that is always visible (see FIG. 2). This page consists of a list of hyperlinks, and is associated with a single program on the server. The navigation program generates a list of possible actions for the current context; if the user selects an action that changes that context, the navigation program is invoked again in the new context, generating a new list.

As an example: the navigation document on the site initially shows a list of existing Week data sets. When the user clicks the link for Week x, the hyperlink instructs the server to run the navigation program again, but this time with a parameter telling it that Week x is the current Week data set. The navigation program then generates the same list as before, but this time it also lists all the Country categories within Week x. The user can then click one of these Country links to list the Days within that Country category, and then list the event records within one of those Day categories. Clicking on an event record calls up the form to edit or delete that record. Also, in the event record and Week lists, there is always a “new Week” or “new event” link, which calls up the appropriate form. The combination of these functions makes it possible to find, edit, create, or delete a record anywhere in the database.

Most of the server's data processing workload occurs within the “make Week” program. This program: (1) loads all the database entries for a given Week data set; (2) generates the cached views for the Week; (3) calculates the MiniGrid summary data and renders the images that will be used by the MiniGrid applet; and (4) when appropriate, changes the initial HTML file to contain the appropriate Week number (since the client cannot be relied upon to calculate the current Week correctly).

The generation of HTML files from the event database is done through the use of template files. These are essentially HTML files, but contain special symbols that tell a custom language interpreter how and where to write database elements into the file. For instance, where an HTML document would contain the title of an event, the corresponding template file would contain a symbol representing the entity “title.” At the time when the HTML file is generated, this symbol is replaced by its current value.

Broadly, the template files contain all the HTML code to determine the structure and appearance of a given view, but not the actual data for the view. The advantage of using templates is that the server software does not need to understand the HTML language to generate HTML code. This understanding is embodied within the template files themselves. Thus, by developing a different set of templates, the system can be easily adapted to generate documents in other languages, such as XML, PostScript, or TeX.

In a preferred embodiment, seven main templates are implemented (see table below). These accommodate all of the views that the user client system may request:

| Template | Countries | Days | Events | |
|---|---|---|---|---|
| Name | Shown | Shown | Shown | Appearance (General) |
| World/Week | All | All | All | All event titles in a |
| | | | | grid format. |
| Country/Day | Single | Single | All | List of event summa- |
| | | | | ries. |
| World/Day | All | Single | All | List of event summa- |
| | | | | ries grouped by Coun- |
| | | | | try. |
| Country/Week | Single | All | All | List of event summa- |
| | | | | ries grouped by Day. |
| Custom/Day | Custom Set | Single | All | List of event summa- |
| | | | | ries grouped by Coun- |
| | | | | try. |
| Custom/Week | Custom Set | All | All | List of event summa- |
| | | | | ries grouped by Coun- |
| | | | | try and by Day. |
| Event | Single | Single | Single | All data for a single |
| | | | | event. |

### Description of Preferred Methods

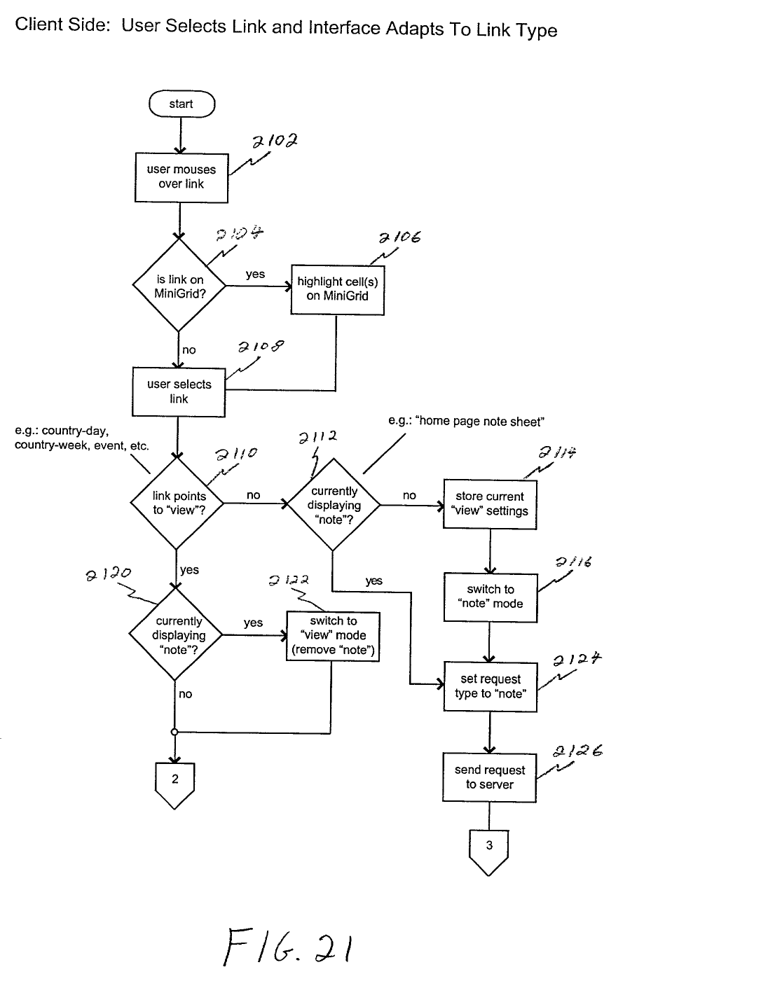

FIGS. 21-24 illustrate steps of preferred methods of the present invention. FIG. 21 illustrates steps of a preferred method whereby a preferred interface adapts to a link type selected by an end-user. Referring to FIG. 21, at step 2102 a user “mouses over” (uses a mouse to place a cursor over) a link on an end-user interface page (see, e.g., FIG. 13). At step 2104 the system checks whether the moused-over link is a link on a MiniGrid 810. If so, then at step 2106 the system highlights the appropriate cell (or cells) on the MiniGrid 810, then waits for the user to select the link. At step 2108, the user selects the link. Each link leads to either a “view” (e.g., a Country-Day such as “United States: Wednesday”) or a “Note” (an HTML document such as that displaying a definition of Gross Domestic Product, in FIG. 12).

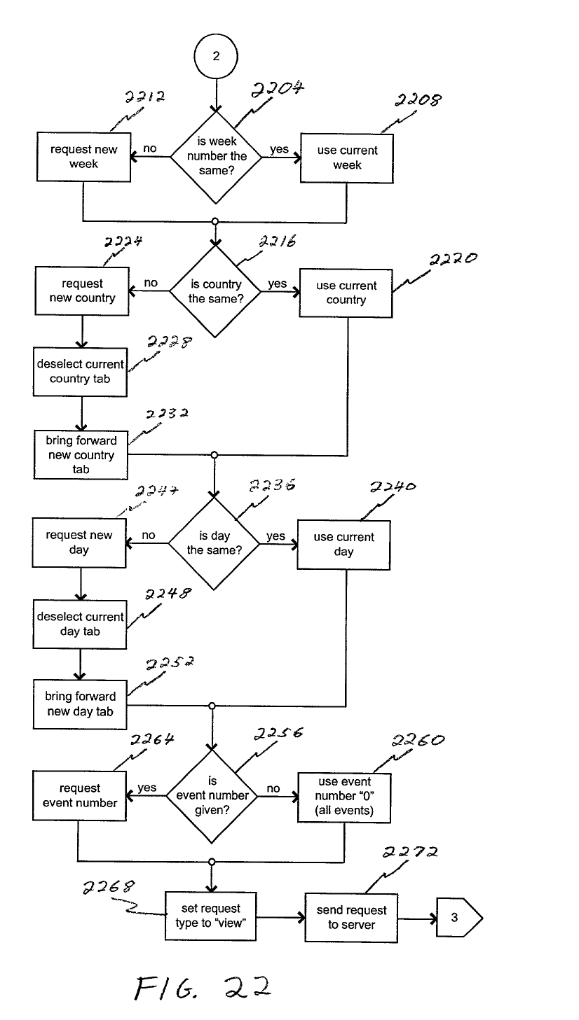

At step 2110, the system checks whether the link selected by the user at step 2108 points to a view. If so, then at step 2120 the system checks whether a note is currently being displayed. If so, at step 2122 the system switches to a view mode, removing the displayed note. If not, the system proceeds to step 2204 (see FIG. 22).

If at step 2110 the system determines that the selected link does not point to a view (and thus points to a note), the system checks at step 2112 whether a note is currently being displayed. If not (i.e., if a view is currently being displayed), then at step 2114 the system stores the current view settings (so that they can be retrieved if and when the note is later removed), then at step 2116 switches to note mode and proceeds to step 2124. If at step 2112 the system determines that a note is currently being displayed (i.e., that it is already in Note mode), it proceeds to step 2124. At step 2124 the system sets the request type to “Note” and at step 2126 sends the request to the server.

Returning to the case where a user selects at step 2108 a link to a view page: after the system is in view mode (steps 2120 and 2122) it proceeds to step 2204 (see FIG. 22, which illustrates how a display frame adapts to a user-selected view), where it checks whether the Week number of the view currently displayed is the same as the Week number of the view selected by the user at step 2108. If the Week number is the same, then at step 2208 the current Week is retained and the system proceeds to step 2216. If the Week number is not the same, then at step 2212 the system requests a new Week (the Week selected by the user at step 2108), then proceeds to step 2216.

At step 2216 the system checks whether the Country of the current display is the same as the Country of the view requested by the user at step 2108. If so, then at step 2220 the system uses the current Country, and proceeds to step 2236. If not, then at step 2224 the system requests a new Country, at step 2228 de-selects the current Country tab, and at step 2232 brings forward the tab of the new (selected) Country. The system then proceeds to step 2236.

At step 2236, the system checks whether the Day of the view currently displayed is the same as the Day of the view selected by the user at step 2108. If so, then at step 2240 the system uses the Day of the view currently displayed, and proceeds to step 2256. If not, then at step 2244 the system requests a new Day, at step 2248 de-selects the current Day tab, and at step 2252 brings forward the tab of the new (selected) Day. The system then proceeds to step 2256.

At step 2256, the system checks whether there is an event (number) associated with the selected view. If not, then at step 2260 the system uses event number “0” (signifying that all events are to be selected for the particular County-Day category), then proceeds to step 2268. If an event number is provided, then at step 2264 the system requests the event record associated with that particular event number for the given Country-Day combination, then proceeds to step 2268.

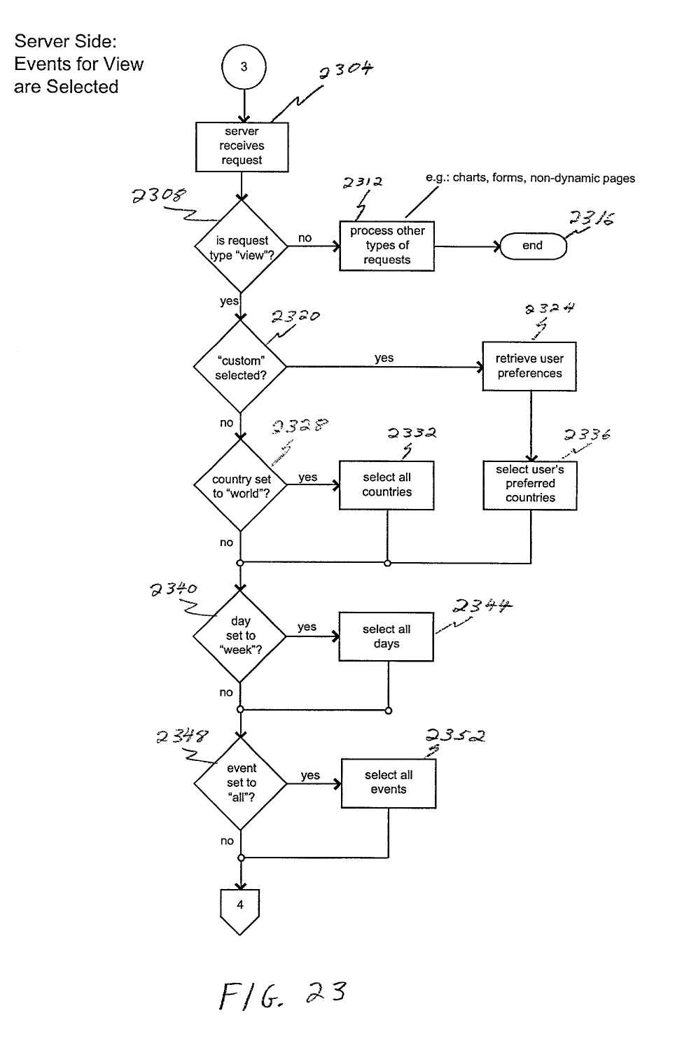

At step 2268, the system sets a request type (here, “request type” refers to an HTTP request; see the “Server” section above) to “view,” and at step 2272 sends the request to the server. At step 2304 (see FIG. 23) the server receives the request that was sent at step 2126 (see FIG. 21) or at step 2272.

Referring to FIG. 23, at step 2308 the server checks whether the request type is “view.” If not, then at step 2316 the server processes whatever type of requests it receives (such as charts, forms, or non-dynamic pages such as notes), and at step 2316 the process ends as far as it relates to requests other than views. If at step 2308 the request type is “view,” then at step 2320 the server checks whether the view is a custom view (whether “custom” has been selected). If so, then at step 2324 the server retrieves the user's custom view preferences, at step 2336 selects the user's preferred countries, and then proceeds to step 2340. If, at step 2320 the server determines that the selected view is not a custom view, then at step 2328 the server checks whether the Country of the selected view is “World.” If so, then at step 2332 the server selects all countries, then proceeds to step 2340. If at step 2328 the Country of the selected view is not “World,” then the server proceeds to step 2340.

At step 2340 the server checks whether the Day of the selected view is “Week.” If so, then at step 2344 the server selects all Days, then proceeds to step 2348. If not, the sever proceeds directly to step 2348.

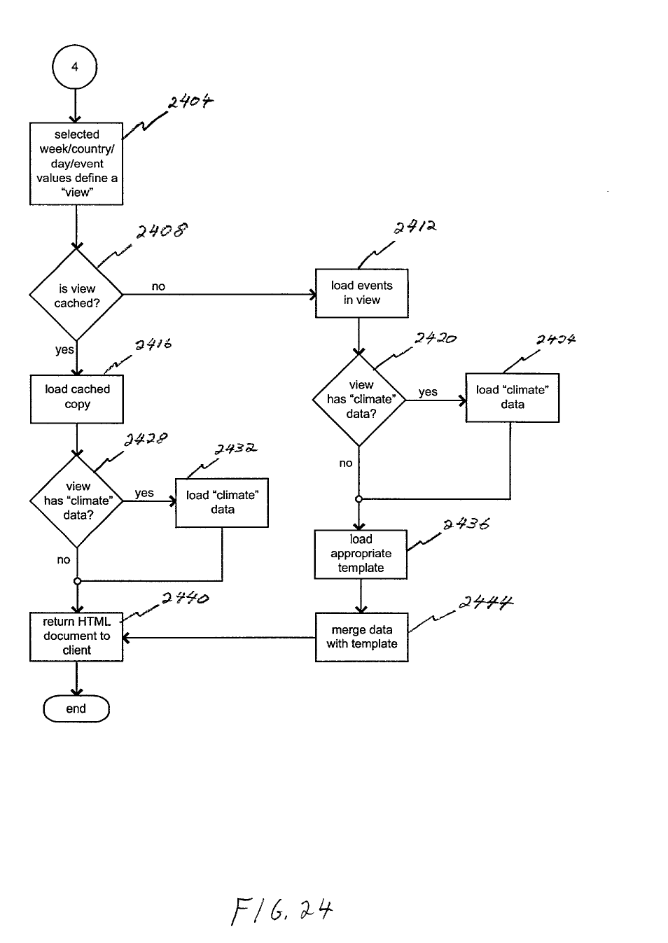

At step 2348 the server determines whether the event setting of the selected view is “all” (i.e., event number “0”). If so, then at step 2352 the server selects all events, then proceeds to step 2404 (see FIG. 24). If not, the server proceeds directly to step 2404.

Referring to FIG. 24, which illustrates how an HTML document for a view is prepared and returned to a client, at step 2404 the server has determined sufficient Week, Country, Day, and event values to define a selected view. The server then checks, at step 2408, whether an HTML document comprising the selected view is cached. If so, then at step 2416 the server loads the cached HTML document. At step 2428 the server checks whether the selected view has associated climate data. If so, then at step 2432 the server loads the associated climate data into the HTML document, then proceeds to step 2404.

If at step 2408 the server determines that the selected view is not cached, then at step 2412 the server loads the events in the view. At step 2420 the server checks whether the selected view has associated climate data. If so, the associated climate data is loaded, and the server proceeds to step 2436. If not, the server proceeds directly to step 2436. At step 2436 the server loads an HTML template appropriate for the selected view, at step 2444 merges the loaded data into the template, and then proceeds to step 2440.

At step 2440 the server transmits an assembled or retrieved HTML document corresponding to the selected view to the client (i.e., to the user).

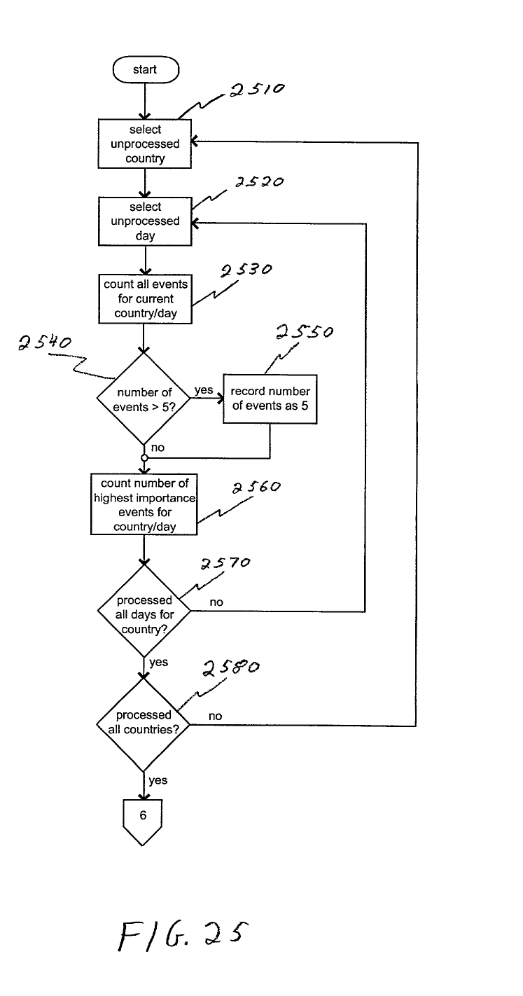

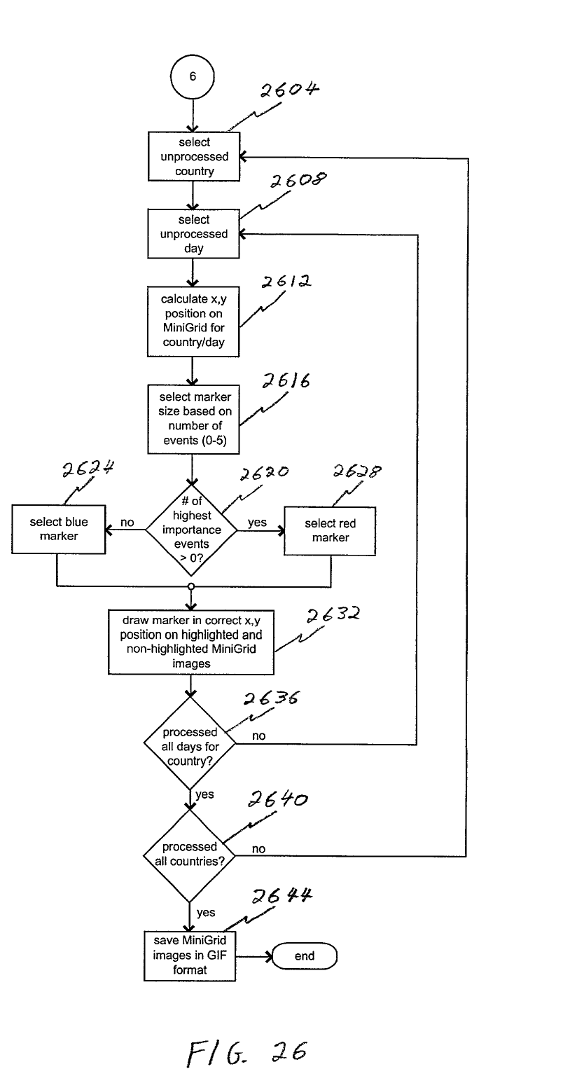

FIGS. 25 and 26 illustrate how events are calculated for representation in a MiniGrid, and how MiniGrid images are compiled.

Referring to FIG. 25, at step 2510 the system selects an unprocessed Country, then at step 2520 selects an unprocessed Day for that Country. At step 2530 system counts all events for the selected (“current”) Country and Day. At step 2540 the system checks whether the number of events is greater than 5. If so, then at step 2550 the system records the number of events as “5,” then proceeds to step 2560. If not, the system proceeds directly to step 2560.

At step 2560 the system counts the number of events for the current Country and Day that have highest importance. At step 2570 the system checks whether it has processed all of the Days for the selected Country. If not, the system returns to step 2520 and repeats step 2520 and subsequent steps. If at step 2570 all Days have been processed for the selected Country, then at step 2580 the system checks whether all countries have been processed. If not, the system returns to step 2510 and repeats step 2510 and subsequent steps. If at step 2580 all countries have been processed, the system proceeds to step 2604 (see FIG. 26).

Referring to FIG. 26, which illustrates how MiniGrid images are compiled, at step 2604 an unprocessed Country is selected. At step 2608 a Day, for the selected Country, that has not been processed is selected. At step 2612 the system calculates the (x, y)-coordinate position on the MiniGrid for the selected Country and Day. At step 2616 a marker size is selected based on the number of events (0-5).

At step 2620 the system checks whether there are any events of highest importance associated with the selected Country-Day (whether the number of highest-importance events is greater than zero). If not, then at step 2624 the system selects a blue marker for the (x, y) position of the selected Country-Day in the MiniGrid, then proceeds to step 2632. If at step 2620 the system determines that there are highest-importance events associated with the selected Country-Day, then at step 2628 the system selects a red marker for the (x, y) position of the selected Country-Day in the MiniGrid, then proceeds to step 2632.

At step 2632, the system draws the selected marker (red or blue) in the (x, y) position in the (highlighted and non-highlighted) MiniGrid images of the selected Country-Day. At step 2636 the system checks whether all Days for the selected Country have been processed. If not, then the system returns to step 2608 and repeats step 2608 and subsequent steps. If at step 2636 the system determines that all Days have been processed for the selected Country, the system proceeds to step 2640, where it checks whether all countries have been processed If all countries have not been processed, the system returns to step 2604 and repeats step 2604 and subsequent steps. If at step 2640 the system determines that all countries have been processed, then at step 2644 the system saves the (highlighted and non-highlighted) MiniGrid images, preferably in GIF format.

While the embodiments shown and described herein are fully capable of achieving the objects of the present invention, it is evident that numerous alternatives, modifications, and variations will be apparent to those skilled in the art in light of the foregoing description. These alternatives, modifications, and variations are within the scope of the present invention, and it is to be understood that the embodiments described herein are shown only for the purpose of illustration and not for the purpose of limitation.

What is claimed is:

1. A method for electronically displaying information, comprising the steps of:
providing a grid display, wherein each column and each row of the grid represents a category of data, wherein each column-row element of the grid corresponds to column-row data, defined as data that is both in the corresponding column category of data and in the corresponding row category of data, and wherein each column-row element of the grid comprises a visual indicator relating to said column-row data;
receiving a request from a user to have selected column-row data displayed; and
displaying said column-row data to said user.

2. A method as in claim 1, wherein the color of said visual indicator relates to a quality of said column-row data.

3. A method as in claim 2, wherein said quality of said column-row data is the relative importance of the data.

4. A method as in claim 1, wherein the size of said visual indicator relates to the quantity of said column-row data.

5. A method as in claim 1, wherein at least one column of said grid corresponds to a day of the week.

6. A method as in claim 5, wherein said day of the week is selected from the group consisting of: Monday, Tuesday, Wednesday, Thursday, and Friday.

7. A method as in claim 1, wherein at least one row of said grid corresponds to a country or area of the world.

8. A method as in claim 7, wherein said country or area of the world is selected from the group consisting of: United States, Great Britain, France, Germany, and Europe.

9. A method as in claim 1, wherein at least one column of said grid corresponds to a day of the week, and wherein at least one row of said grid corresponds to a country or area of the world.

10. A method as in claim 1, further comprising the step of displaying tabs along a first side and an adjacent second side of a rectangular viewing area, wherein at least one tab along said first side corresponds to a column of said grid and at least one tab along said adjacent second side corresponds to a row of said grid.

11. A method as in claim 1, wherein the step of receiving a request from said user to have selected column-row data displayed comprises receiving data indicating that a mouse cursor was placed over a displayed area corresponding to the column-row element corresponding to said column-row data and that a mouse button was clicked while the mouse cursor was over said area.

12. A method as in claim 10, wherein the step of receiving a request from said user to have selected column-row data displayed comprises:
receiving data indicating that a mouse cursor was placed over a first tab corresponding to the column in the column and row corresponding to said column-row data and that a mouse was clicked while said mouse cursor was over said first tab; and
receiving data indicating that a mouse cursor was placed over a second tab corresponding to the row in the column and row corresponding to said column-row data and that a mouse was clicked while said mouse cursor was over said second tab.

13. A method as in claim 9, wherein said column-row data comprises textual information relating to an event that:
(a) is expected to occur or has occurred on a day corresponding to the column in the column and row corresponding to said column-row data; and
(b) relates to a country corresponding to the row in the column and row corresponding to said column-row data.

14. A method as in claim 13, wherein said column-row data displayed to said user further comprises a visual indicator providing a summary of said textual information.

15. A method as in claim 14, wherein said visual indicator is an icon.

16. A method as in claim 15, wherein said textual information relating to an event comprises a forecast of an expected outcome of the event.

17. A method as in claim 16, wherein said icon is a weather icon that provides a visual indication of said expected outcome.

18. A method of electronically displaying data, comprising the steps of:
(a) receiving data through HTML forms;
(b) storing said entered data in a database system;
(c) generating from said stored data HTML code for presentation to users;
(d) in response to a request from a user, assembling appropriate HTML fragments to form a complete document; and
(e) transmitting the complete document to the requesting user.

19. A method as in claim 18, wherein said generated HTML code is cached if the view corresponding to the code is of a type expected by a grid display provider to be requested frequently.

20. A system for electronically displaying information, comprising:
means for providing a grid display, wherein each column and each row of the grid represents a category of data, wherein each column-row element of the grid corresponds to column-row data, defined as data that is both in the corresponding column category of data and in the corresponding row category of data, and wherein each column-row element of the grid comprises a visual indicator relating to said column-row data;
means for receiving a request from a user to have selected column-row data displayed; and
means for displaying said column-row data to said user.

21. A system as in claim 20, wherein the color of said visual indicator relates to a quality of said column-row data.

22. A system as in claim 21, wherein said quality of said column-row data is the relative importance of the data.

23. A system as in claim 20, wherein the size of said visual indicator relates to the quantity of said column-row data.

24. A system as in claim 20, wherein at least one column of said grid corresponds to a day of the week.

25. A system as in claim 20, wherein at least one row of said grid corresponds to a country or area of the world.

26. A system as in claim 20, wherein at least one column of said grid corresponds to a day of the week, and wherein at least one row of said grid corresponds to a country or area of the world.

27. A system as in claim 20, further comprising means for displaying tabs along a first side and an adjacent second side of a rectangular viewing area, wherein at least one tab along said first side corresponds to a column of said grid and at least one tab along said adjacent second side corresponds to a row of said grid.

28. A system as in claim 20, wherein the means for receiving a request from said user to have selected column-row data displayed comprises means for receiving data indicating that a mouse cursor was placed over a displayed area corresponding to the column-row element corresponding to said column-row data and that a mouse button was clicked while the mouse cursor was over said area.

29. A system for electronically displaying data, comprising:
(a) means for receiving data through HTML forms;
(b) means for storing said entered data in a database system;
(c) means for generating from said stored data HTML code for presentation to users;
(d) means for, in response to a request from a user, assembling appropriate HTML fragments to form a complete document; and
(e) means for transmitting the complete document to the requesting user.

30. A system as in claim 29, wherein said generated HTML code is cached if the view corresponding to the code is of a type expected by a grid display provider to be requested frequently.

31. A system for providing a grid display to a user, comprising:
a computer-readable data storage device storing one or more databases; and
a server connected to said data storage device and connected to a computer network, said server configured to:
provide a grid display over said computer network to a user, wherein each column and each row of the grid represents a category of data, wherein each column-row element of the grid corresponds to column-row data, defined as data that is both in the corresponding column category of data and in the corresponding row category of data, and wherein each column-row element of the grid comprises a visual indicator relating to said column-row data;
receive a request over said computer network from the user to have selected column-row data displayed; and
display, over said computer network, said column-row data to said user.
